(19) United States
(12) Patent Application Publication
(10) Pub. No.: US 2003/0112482 A1
(43) Pub. Date: Jun. 19, 2003

(54) Solid state image sensor, image scanner, and image scanning program

(75) Inventors: Nobuhiro Fujinawa, Kanagawa-ken (JP); Toshiya Aikawa, Kanagawa-ken (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/314,323

(22) Filed: Dec. 9, 2002

(30) Foreign Application Priority Data
Dec. 14, 2001 (JP) 2001-382221

(51) Int. Cl. H04N 1/46

(52) U.S. Cl. 358/513

(57) ABSTRACT

The present invention provides a solid state image sensor, an image scanner, and an image scanning program which realize substantial shortening of the total scan time of one screen of an original even if a required time for one cycle of processings is not shortened. In order to achieve this object, a solid state image sensor of the present invention includes: two or more linear arrays of photosites in which plural photosites for accumulating charge according to incident light are closely and one-dimensionally arranged in one direction; and a transfer part for transferring array by array the charge accumulated in each of the photosites of these two or more linear arrays, in which the two or more linear arrays of photosites are closely arranged in a direction perpendicular to the one direction in a rectangular region which is long in the one direction.

### BACKGROUND OF THE INVENTION

1. Field of the Invention

The present invention relates to a solid state image sensor for capturing light from a transparent original (a developed photo film, for example) and a reflective original (paper, for example) as an image, and an image scanner and an image scanning program for scanning images of the transparent original and the reflective original.

2. Description of the Related Art

A conventional scanner (an image scanner) is known, which scans images of a transparent original, and a reflective original (collectively referred to as an original) and inputs image data thereof in a host computer. The scanner incorporates an inexpensive monochrome one-array sensor (one-dimensional solid state image sensor) as an image sensor for capturing light (transmitting light or reflective light) from the original as an image. As shown in FIG. 13, in the monochrome one-array sensor, plural photosites 51 are one-dimensionally arranged. Further, a sub-scan mechanism for relatively moving the monochrome one-array sensor and the original in a direction perpendicular to a direction of scan (main scan) by the monochrome one-array sensor is also incorporated in the scanner.

In such a scanner, one-array scan by the monochrome one-array sensor and one-array moving by the sub-scan mechanism are alternately repeated so that the image of the original is two-dimensionally scanned. It should be noted that the one-array scan by the monochrome one-array sensor signifies exposing the plural photosites 51 provided in the monochrome one-array sensor.

Note that when a color image of the original is two-dimensionally scanned using the monochrome one-array sensor, color separation of three colors of red (R), green (G), and blue (B) is performed by switching light emission of an illumination source to the original, and the one-array scan by the monochrome one-array sensor is performed in sequence for each of the colors as, for example, R exposure→G exposure→B exposure. Then, when the exposure of the final color (B) is completed, the one-array moving by the sub-scan mechanism is performed.

In other words, scan of the two-dimensional image (one screen) using the aforesaid three colors is repeat of a sequence of “one-array scan (R exposure→G exposure→B exposure)→one-array moving” (see FIG. 14).

Incidentally, charge (R image data) accumulated in each of the photosites 51 of the monochrome one-array sensor due to the exposure of the initial color (R) starts to be transferred simultaneously with start of the next G exposure. Charge (G image data) accumulated in each of the photosites 51 due to the G exposure starts to be transferred simultaneously with start of the next B exposure. Charge (B image data) accumulated due to the exposure of the final color (B) starts to be transferred simultaneously with start of the one-array moving or during the middle of the one-array moving. Usually, the transfer of the B image data is completed during the one-array moving.

Here, a period for the one-array moving (from the completion of the B exposure of the final color to the start of the R exposure of the initial color) is a non-exposure period during which each of the photosites 51 of the monochrome one-array sensor is not exposed.

However, even during the non-exposure period, some unnecessary charge is accumulated in each of the photosites 51. Thus, the unnecessary charge (invalid data) accumulated during the non-exposure period starts to be transferred simultaneously with the start of the R exposure of the initial color.

As stated above, in scanning the two-dimensional image (one screen) using the aforesaid three colors, a sequence of “transfer of invalid data→transfer of R image data→transfer of G image data→transfer of B image data” is repeatedly performed in parallel to the sequence of “the R exposure→the G exposure→the B exposure→the one-array moving”.

It should be noted that fixed time is required from the start to the completion of the transfer of various data (one-array data) in the monochrome one-array sensor irrespective of a kind of data. This fixed time is determined by the product of the number of the photosites 51 of the monochrome one-array sensor by a clock cycle. Hereinafter, the fixed time is referred to as “one-array transfer time (Tt)”.

Incidentally, in scanning the color image (one screen) by a conventional scanner, time (T1) required for one cycle from the start of the above two sequences related to one array to the completion thereof is expressed in the following formula (1) when time of the R exposure (TR), time of the G exposure (TG), and time of the B exposure (TB) are longer than the one-array transfer time (Tt) (FIG. 14A). Tm indicates time for one-array moving.

T1=TR+TG+TB+Tm (1)

(TR, TG, TB>Tt)

In this case, if the exposure time (TR, TG or TB) of each color is shortened by increasing intensity of a light source, the time (T1) required for one cycle can be also shortened. The exposure time (TR, TG or TB) of each color is equal to irradiation time of light irradiated from an illumination source to the original.

However, in the conventional scanner, when the exposure time (TR, TG or TB) of each color becomes shorter than the one-array transfer time (Tt) as shown in FIG. 14B, the time (T1) required for one cycle cannot be shortened even if the exposure time of other colors (TR and TG) than the final color (B) is further shortened because there is restriction by the one-array transfer time (Tt). The time (T1) in this case is expressed in the following formula (2).

T1=Tt+Tt+TB+Tm (2)

(TR, TG, TB<Tt)

Further, it can be considered that the time (Tm) of the one-array moving is shortened in order to shorten the time (T1) required for one cycle, but the time (T1) required for one cycle cannot be reduced to be shorter than four times of the one-array transfer time (Tt) even if the time (Tm) of one-array moving is reduced to be shorter than time (Tmm) shown in FIG. 14B. In other words, time of four times as the one-array transfer time (Tt) is necessary at shortest for the time (T1) required for one cycle.

Here, when the number of the photosites 51 of the monochrome one-array sensor (FIG. 13) is supposed to be 4000 and the clock cycle is supposed to be 400 ns (a 4000 dpi class is assumed), the shortest time T1 required for one cycle is the one-array transfer time (Tt)×4=4000×400 ns×4=6.4 ms.

Incidentally, although a method of increasing a speed of the clock cycle of the monochrome one-array sensor can be also considered in order to shorten the time (T1) required for one cycle, the substantial increase in speed of the clock cycle is technically difficult and as a result, the required time (T1) cannot be expected to be substantially shortened.

Further, in place of the aforesaid constitution of the monochrome one-array sensor and switching of light emission of the illumination source, the configuration using a color three-array sensor (FIG. 15) can be also considered. In this case, the R exposure, the G exposure, and the B exposure can be simultaneously performed as shown in FIG. 16 so that time for scanning one array (time for the exposure of the three colors) can be substantially shortened.

However, even when the color three-array sensor is used, one-array moving has to be performed after scanning one array (the exposure of the three colors) in order to scan the two-dimensional image (one screen) of the original. Further, fixed delay time (TD) exists in the sub-scan mechanism for performing one-array moving from the time when it receives a drive pulse to the time when it actually starts moving. Considering the time (Tm) of one-array moving and the delay time (TD), time (T2) required for one cycle when the color three-array sensor is used is not much different from the required time (T1) in FIG. 14B described above.

### SUMMARY OF THE INVENTION

Thus, an object of the present invention is to provide a solid state image sensor, an image scanner, and an image scanning program which realize substantial shortening of a total scanning time of one screen of an original without shortening a required length of time for one cycle of the processings.

A solid state image sensor according to the present invention comprises: two or more linear arrays of photosites in which a plurality of photosites for accumulating charge according to incident light are closely and one-dimensionally arranged in one direction; and transfer parts provided for the two or more linear arrays of photosites, respectively, for transferring, array by array, the charge accumulated in each of the photosites of the two or more linear arrays of photosites, in which the two or more linear arrays of photosites are closely arranged in a rectangular region in a direction perpendicular to the one direction, the rectangular region being long in the one direction.

Use of this solid state image sensor achieves shortening of a total scanning time of one screen of the original without reducing a required time for the one cycle of the processings, which results in reduction of work hours and increased efficiency. Further, it is also possible to realize higher resolution of an image without elongating the total scanning time of one screen.

Furthermore, an image scanner according to the present invention comprises: an illuminating section for irradiating illumination to an original; the solid state image sensor for capturing as an image light from the original to which the illumination is irradiated; a moving section for relatively moving a captured area and the original sensor in a sub-scan direction corresponding to the perpendicular direction of the solid state image sensor, the captured area being an area on said original corresponding to the rectangular region of the solid state image sensor; and a control section for scanning a two-dimensional image of the original by controlling at least the solid state image sensor and the moving section, in which the control section includes a transfer control part for controlling the solid state image sensor to transfer the charge accumulated in each of the plurality of photosites in the rectangular region, and in which the transfer control part simultaneously controls the transfer parts to simultaneously transfer the charge from each of the linear arrays of photosites.

Here, the control section includes a move control part for controlling the moving section to relatively move the captured area and the original by a fixed distance in the sub-scan direction after the illuminating section irradiates the illumination. The fixed distance is determined to be a length equal to a length of the captured area in the sub-scan direction.

Moreover, the control section includes a move control part for controlling the moving section to relatively move the captured area and the original by a fixed distance in the sub-scan direction after the illuminating section irradiates the illumination, and this time the fixed distance is determined to be a length obtained by dividing the length of the captured area in the sub-scan direction by the number of the linear arrays of photosites.

In addition, the control section includes a move control part for controlling the moving section to relatively move the captured area and the original by a fixed distance in the sub-scan direction after the illuminating section irradiates the illumination, and the fixed distance here is set, according to a scan mode of the two-dimensional image of the original, to either the length of the captured area in the sub-scan direction or the length obtained by the dividing.

Further, an image scanning program according to the present invention is a program for scanning a two-dimensional image of an original by controlling at least a solid state image sensor and a moving section of an image scanner. The image scanner comprises: an illuminating section for irradiating illumination to the original; a solid state image sensor for capturing as an image light from the illuminated original; and a moving section for relatively moving a captured area and the original in a sub-scan direction corresponding to the perpendicular direction of the solid state image sensor, the captured area being an area on the original corresponding to the rectangular region of the solid state image sensor. The image scanning program comprises: a transfer controlling step of controlling the solid state image sensor to transfer charge accumulated in each of photosites in the rectangular region, and in the transfer control step, transfer parts each provided for each of linear arrays of photosites is simultaneously controlled to simultaneously transfer the charge from each of the linear arrays of photosites.

Here, the image scanning program further comprises: a moving controlling step of controlling the moving section to relatively move the captured area and the original by a fixed distance in the sub-scan direction after the illuminating section irradiates the illumination, and, in the moving controlling step, the captured area and the original are relatively moved so that the fixed distance becomes equivalent to the length of the captured area in the sub-scan direction.

Further, the image scanning program further comprises: a moving controlling step for controlling the moving section to relatively move the captured area and the original by a fixed distance in the sub-scan direction after the illuminating section irradiates the illumination, and, in the move control step, the captured area and the original are relatively moved so that the fixed distance becomes a length obtained by dividing the length of the captured area in the sub-scan direction by the number of the linear arrays of photosites.

The image scanning program further comprises: a moving controlling step of controlling the moving section to relatively move the captured area and the original by a fixed distance in the sub-scan direction after the illuminating section irradiates the illumination, and, in the move control step, the fixed distance is set by switching to either the length of the captured area in the sub-scan direction or the length obtained by the dividing in the sub-scan direction by the number of the linear arrays of photosites, according to a scan mode of the two-dimensional image of the original, thereby relatively moving the captured area and the original.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1A is a side view of the internal structure of an image scanner 10 of a first embodiment;

FIG. 1B is a front view of the internal structure of the image scanner 10;

FIG. 2A is an external side view of an image sensor 17 incorporated in the image scanner 10;

FIG. 2B is an external bottom view of the image sensor 17 in FIG. 2A;

FIG. 2C is an enlarged schematic view of a main part of the image sensor 17;

FIG. 3A is a schematic view explaining a captured area 12b on an original 12 by the image sensor 17;

FIG. 3B is a view explaining relationship in arrangement between the image sensor 17 and the captured area 12b;

FIG. 4 is a block diagram of the image scanner 10;

FIG. 5 is a flow chart of the image scanning operation in the first embodiment;

FIG. 6 is a timing chart of the image scanning operation in the first embodiment;

FIG. 7A is a schematic diagram explaining a state in which a scan range of the original 12 is scanned by two linear arrays 8a and 8b of photosites;

FIG. 7B is a schematic diagram explaining scan by the linear arrays 8a and 8b of photosites;

FIG. 7C is a schematic diagram explaining scan by the linear arrays 8a and 8b of photosites;

FIG. 7D is a schematic diagram explaining scan by the linear arrays 8a and 8b of photosites;

FIG. 7E is a schematic diagram explaining scan by the linear arrays 8a and 8b of photosites;

FIG. 7F is a schematic diagram explaining scan by the linear arrays 8a and 8b of photosites;

FIG. 7G is a schematic diagram explaining scan by the linear arrays 8a and 8b of photosites;

FIG. 8 is a flow chart of image scanning operation in a second embodiment;

FIG. 9 is a timing chart of the image scanning operation in the second embodiment;

FIG. 10A is a schematic diagram explaining a state in which a scan range of the original 12 is scanned by the two linear arrays 8a and 8b of photosites in the second embodiment;

FIG. 10B is a schematic diagram explaining scan by the linear arrays 8a and 8b of photosites;

FIG. 10C is a schematic diagram explaining scan by the linear arrays 8a and 8b of photosites;

FIG. 10D is a schematic diagram explaining scan by the linear arrays 8a and 8b of photosites;

FIG. 10E is a schematic diagram explaining scan by the linear arrays 8a and 8b of photosites;

FIG. 10F is a schematic diagram explaining scan by the linear arrays 8a and 8b of photosites;

FIG. 10G is a schematic diagram explaining scan by the linear arrays 8a and 8b of photosites;

FIG. 11 is a chart showing output characteristics of the two linear arrays 8a and 8b of photosites relative to an exposure amount;

FIG. 12 is a schematic view showing the structure of a color image sensor 37 to which the present invention is applied;

FIG. 13 is a schematic view showing the structure of a monochrome one-array sensor incorporated in a conventional scanner;

FIG. 14A is a timing chart of the image scanning operation when the monochromes one-array sensor is used (TR, TG, TB>Tt);

FIG. 14B is a timing chart of the image scanning operation when the monochromes one-array sensor is used (TR, TG, TB<Tt);

FIG. 15 is a schematic view showing the structure of a color three-array sensor incorporated in the conventional scanner; and

FIG. 16 is a timing chart of the image scanning operation when the color three-array sensor is used.

### DESCRIPTION OF THE PREFERRED EMBODIMENTS

Hereinafter embodiments of the present invention will be explained in detail with reference to the drawings.

(First Embodiment)

An example of an image scanner 10 for scanning a color image of an original by transmitted illumination will be explained here. The original in this case is a transparent original (a developed photo film, for example).

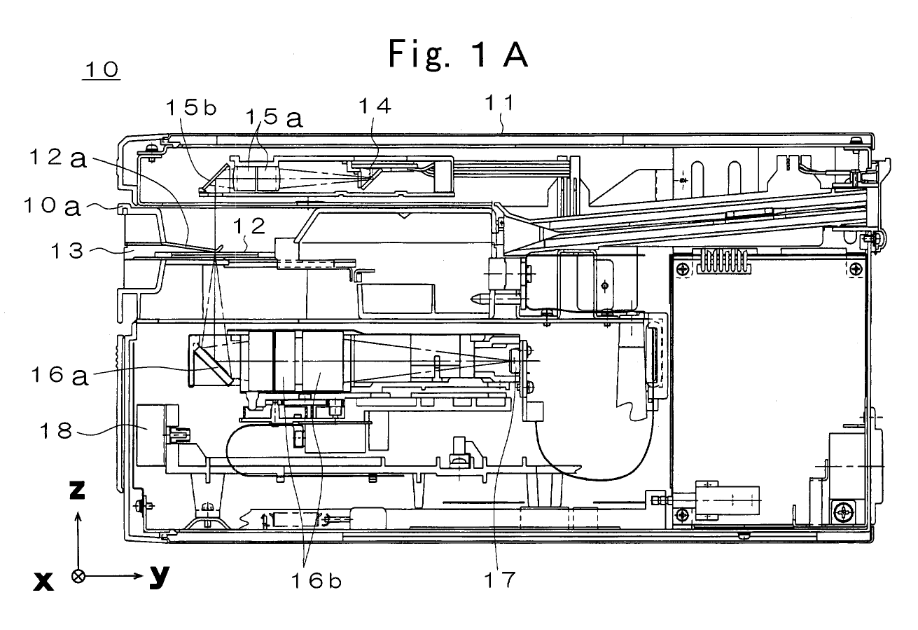

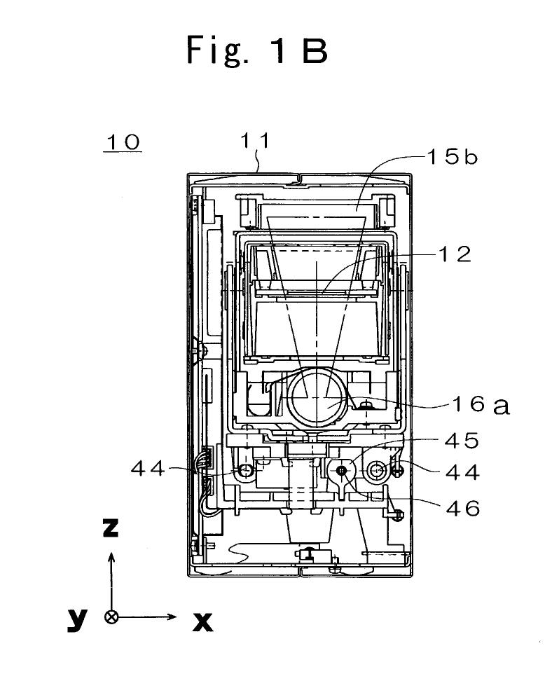

Several kinds of adapters are settable to the image scanner 10 and they can be individually used depending on types of transparent originals to be scanned. FIGS. 1A and B show the image scanner 10 with a slide mount adapter 10a set thereto.

As shown in FIGS. 1A and 1B, an insertion port 13 of an original 12 is provided on a side face of a case 11 of the image scanner 10 in a first embodiment. The original 12 is held with a slide mount adapter. The original 12 is inserted from the insertion port 13 into the case 11, and fixed in a predetermined position by a spring member 12a (a state shown in FIG. 1A).

Here, an insertion direction of the original 12 into the image scanner 10 is defined as a Y direction, a width direction of the original 12 is defined as an X direction, and a direction perpendicular to the X direction and the Y direction is defined as a Z direction. The insertion port 13 is an opening having a thin slit shape in the X direction.

Further, an illumination source 14, an illumination lens 15a, and a reflective mirror 15b are provided above the original 12 inside the case 11 of the image scanner 10. The illumination source 14 is composed of a light-emitting diode (LED) for emitting light of red (R) color, an LED for emitting light of green (G) color, and an LED for emitting light of blue (B) color (any of which is not shown).

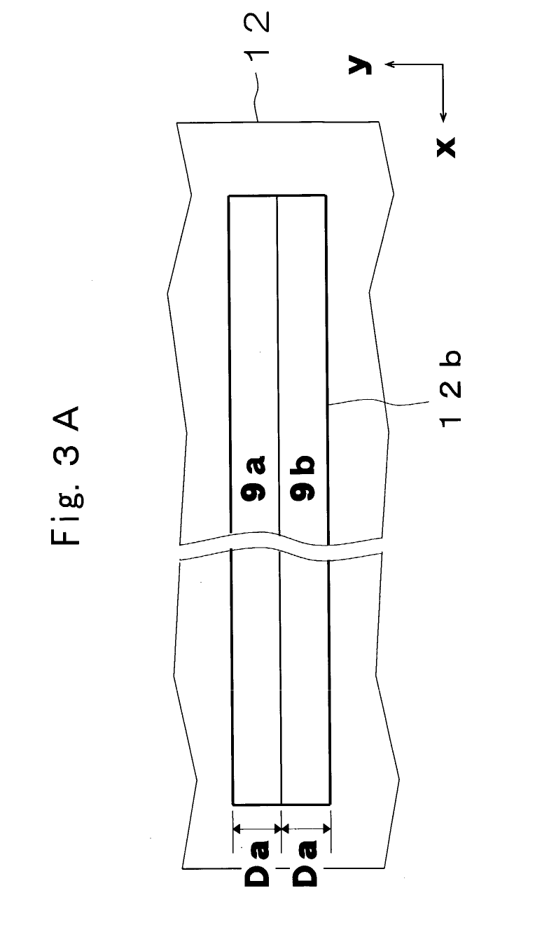

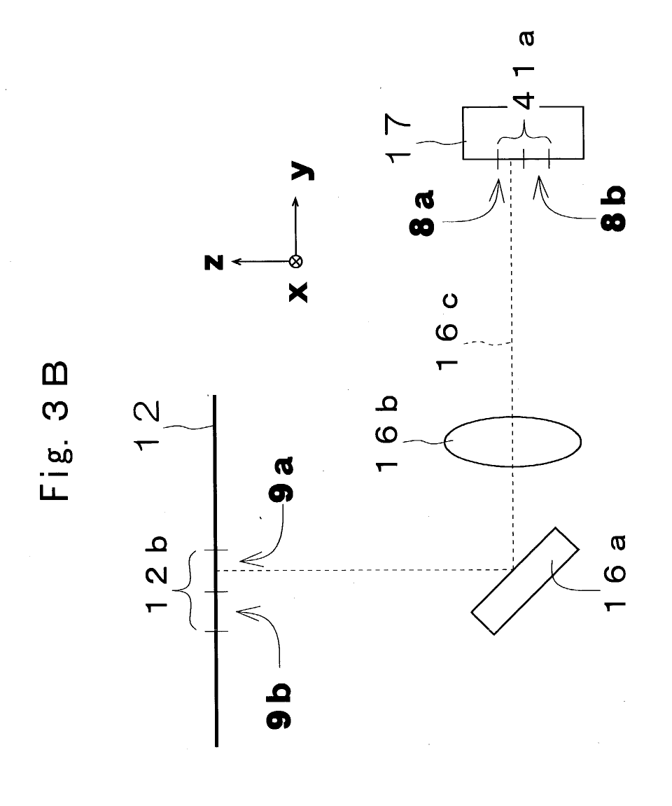

The illumination lens 15a converts light irradiated from the illumination source 14 to linear light in the X direction. The reflective mirror 15b reflects the linear light from the illumination lens 1 Sa toward the original 12. With these illumination source 14, illumination lens 15a, and reflective mirror 15b, the linear light in the X direction (illumination) is irradiated to the original 12. The illumination is irradiated to a region in the original 12 corresponding to at least two arrays (a captured area 12b in FIGS. 3A and 3B which will be described later).

Further, inside the case 11 of the image scanner 10, a reflective mirror 16a, a projection lens 16b, and an image sensor 17 are provided below the original 12. The reflective mirror 16a reflects transmitting light from the original 12 toward the projection lens 16b. The projection lens 16b forms an image in the image sensor 17 from the light from the reflective mirror 16a.

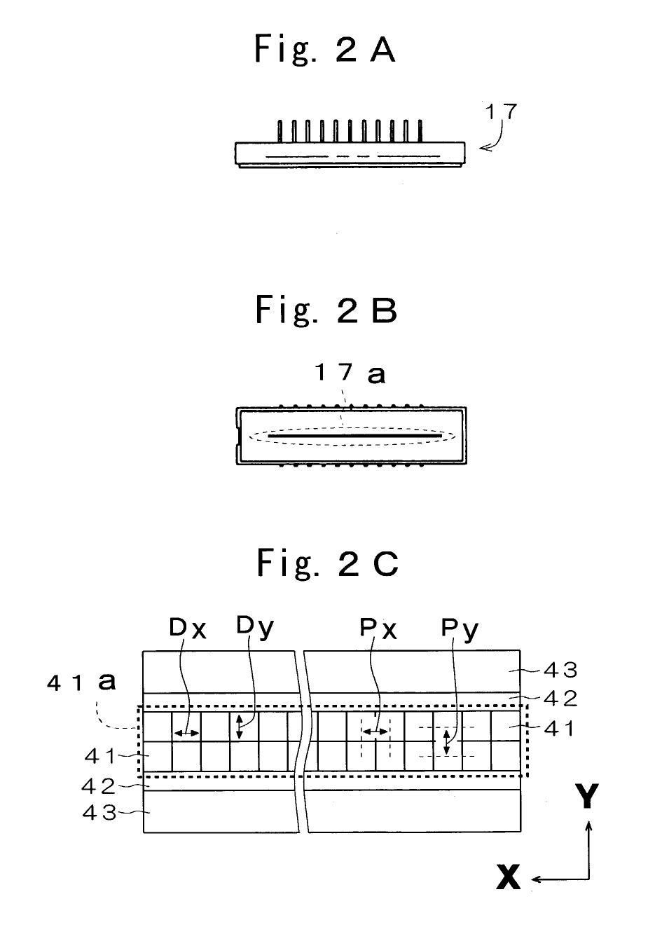

The image sensor 17 is a monochrome image sensor for capturing the light from the projection lens 16b (the transmitting light from the original 12) as an image. Here, the structure of the image sensor 17 will be explained in detail with reference to FIGS. 2A to 2C.

FIG. 2A is an external side view of the image sensor 17, and FIG. 2B is an external view thereof seen from a projection lens 16b side. FIG. 2C is a schematic view showing an enlarged main part 17a (FIG. 2B) of the image sensor 17.

As shown in FIG. 2C, in the image sensor 17 provided are plural (for example, 8000 of) photosites 41 for accumulating charge according to incident light (the transmitting light from the original 12), read-out gates (ROG) 42 for transferring the charge accumulated in these photosites 41, and CCD analog shift registers 43.

Further, in the image sensor 17, the plural photosites 41 are disposed in a rectangular region 41a which is long in one direction (a region shown by a dotted frame in the drawing). Note that for explanation of the image sensor 17, a longitudinal direction of the rectangular region 41a is defined as an X direction and a width direction thereof (a direction perpendicular to the X direction) is defined as a Y direction.

Moreover, the plural photosites 41 are arranged in square lattices in the X direction and the Y direction in the rectangular region 41a. In the first embodiment, the number Ny of the photosites 41 arranged in the Y direction is two.

Accordingly, in the rectangular region 41a, two lines of the photosites 41 exist each of which is arranged in one dimension in the X direction (hereinafter referred to as a “linear array”). Incidentally, when the total number of the photosites 41 is Na (for example, 8000), the number Nx of the photosites 41 in each of the linear arrays is Na/Ny (for example, 4000).

Further, since the plural photosites 41 are arranged in the square lattices, pitches of the plural photosites 41 are constant irrespective of the arrangement directions of the photosites 41. In other words, a pitch Px of the photosites 41 in the X direction (a pitch in each of the linear arrays) is equal to a pitch Py in the Y direction (a pitch between the two linear arrays).

Furthermore, the plural photosites 41 are disposed closely to each other. Therefore, the aforesaid pitches Px and Py are equal to the lengths Dx and Dy of each of the photosites 41 (both of which are 8 μm).

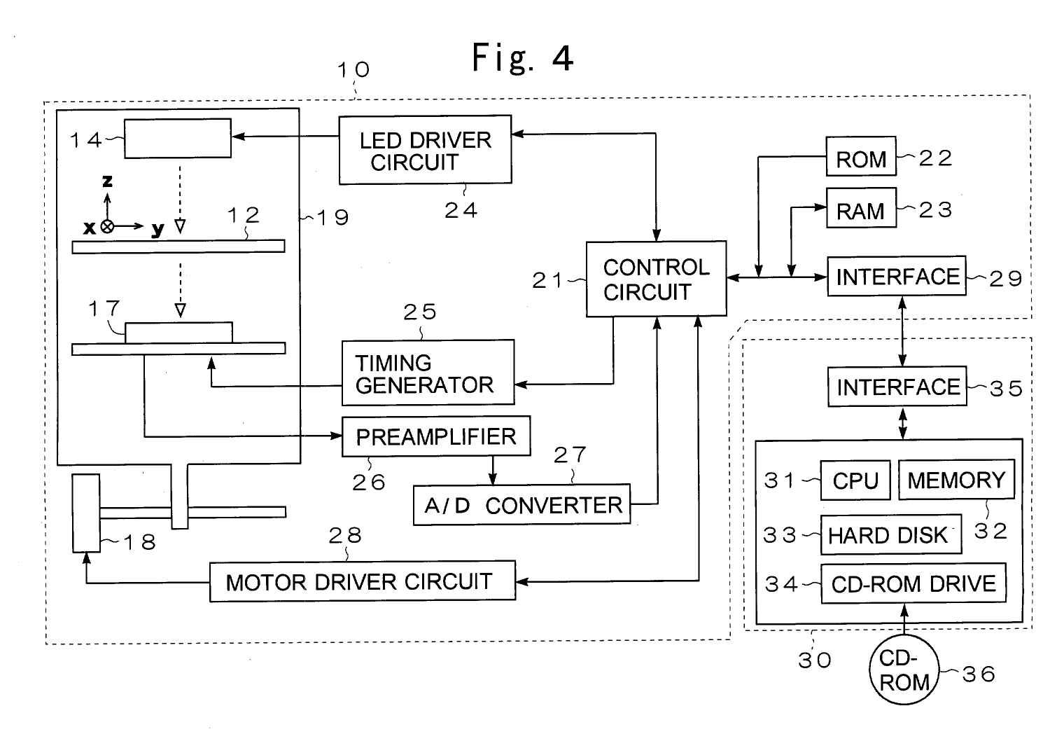

Moreover, in the image sensor 17, the read-out gate 42 and the CCD analog shift register 43 are provided for each of the two linear arrays described above. The read-out gate 42 transfers charge in parallel from the photosites 41 in each of the linear arrays to the CCD analog shift register 43. The CCD analog shift register 43 transfers the charge from the read-out gate 42 in serial so as to output it to a preamplifier 26 which will be described later (FIG. 4).

Thus-structured image sensor 17 is disposed in the case 11 of the image scanner 10 (FIGS. 1A and 1B) in the following orientation. Specifically, the longitudinal direction (the X direction) of the rectangular region 41a of the image sensor 17 is aligned with the width direction (the X direction) of the original 12 described above, and the width direction of the rectangular region 41a (the Y direction) is aligned with the above-described Z direction.

The aforesaid reflective mirror 16a is disposed between the image sensor 17 and the original 12, however, the width direction (the Y direction) of the rectangular region 41a corresponds to the insertion direction (the Y direction) of the original 12 on the original 12. In other words, the width direction (the Y direction) of the rectangular region 41a of the image sensor 17 is aligned with the insertion direction (the Y direction) of the original 12, optically.

Therefore, a region on the original 12 corresponding to the rectangular region 41a of the image sensor 17 (the captured area 12b in FIG. 3A) is a rectangular region which is long in the X direction (the width direction of the original 12) similarly to the rectangular region 41a. Further, a width direction of the captured area 12b is parallel to the Y direction (the insertion direction of the original 12).

The captured area 12b on the original 12 is a region projected onto the rectangular region 41a of the image sensor 17 with the projection lens 16b. Accordingly, the light transmitting through the captured area 12b on the original 12 is incident on the rectangular region 41a of the image sensor 17 and received by the plural photosites 41 (the two linear arrays of photosites).

Further, as shown in FIG. 3B, the image sensor 17 is fixed, in the aforesaid orientation, in such a position as one of the two linear arrays of photosites (hereinafter referred to as a “linear array 8a”) intersects an optical axis 16c of the projection lens 16b and the other (hereinafter referred to as a “linear array 8b”) deviates from the optical axis 16c in a lower side (an opposite side to the original 12).

At this time, linear arrays on the original 12 (captured linear arrays 9a and 9b) correspond to the linear arrays 8a and 8b of the image sensor 17, and the captured linear array 9b is positioned closer to an insertion port 13 (FIG. 1A) than the captured linear array 9a. Then, the light transmitting through the captured linear array 9a and 9b on the original 12 is incident onto the linear arrays 8a and 8b of the image sensors 17 and received respectively.

The length Da (FIG. 3A) of the aforesaid captured linear array 9a or 9b in the Y direction is determined by the length of the linear array 8a or 8b in the Y direction (the length corresponding to the length Dy of the photosite 41) and by magnification of the projection lens 16b. For example, when the length Dy of the photosite 41 is 8 μm and the magnification of the projection lens 16b is 1.26, the length Da of the captured linear array 9a or 9b is 6.35 μm (=8 μm/1.26). This corresponds to 4000 dpi on the original 12.

The photosites 41 of the two linear arrays 8a and 8b of the image sensor 17 are thus exposed to the transmitting light from the captured linear array 9a and 9b of the original 12 respectively, and accumulate the charge. In the image sensor 17, each of the photosites 41 is exposed generally in parallel with transfer of the charge in the read-out gates 42 and the CCD analog shift registers 43.

Further, in the case 11 of the image scanner 10, as shown in FIG. 4, provided is a scan block 19 which is step-movable at fine intervals in the Y direction. The scan block 19 is a case for accommodating and integrating a scanning system composed of the aforesaid illumination part (14, 15a, and 15b) and projection part (16a, 16b, and 17). The illumination lens 15a, the reflective mirrors 15b and 16a, and the projection lens 16b are not shown in FIG. 4.

The scan block 19 is guided by guide bars 44 and movable in the Y direction. The scan block 19 has a motor 18 mounted thereon via a not-shown reduction gear train, and a nut 45 and a lead screw 46 shown in FIG. 1B. The motor 18 is a stepping motor.

The rotation of the motor 18 rotates and drives the lead screw 46 via the reduction gear train (not shown) to move the nut 45 in the Y direction so that the guide bars 44 guide the scan block 19 to move in the Y direction. As a result, the illumination part (14, 15a, and 15b) and the projection part (16a, 16b, and 17) mounted on the scan block 19 move in the Y direction.

In other words, an illumination area (the linear region in the X direction) by the illumination part (14, 15a, and 15b) and the captured area 12b (FIGS. 3A and 3B) by the projection part (16a, 16b, and 17) move in the Y direction relative to the fixed original 12. The Y direction corresponds to a “sub-scan direction”.

Incidentally, a reduction ratio of the reduction gear train (not shown) and pitches of the nut 45 and the lead screw 46 are designed in a manner that the scan block 19 moves by the length (2×Da) in the Y direction of the captured area 12b (FIGS. 3A and 3B) when the motor 18 rotates by a unit step angle.

As stated above, on the assumption that the length Dy of the photosite 41 of the image sensor 17 is to be 8 μm and the magnification of the projection lens 16b to be 1.26, a moving distance (2×Da) of the scan block 19 when the motor 18 rotates by the unit step angle will be 12.7 m (=2×6.35 μm).

In addition, in the image scanner 10, a control circuit 21, a ROM 22, a RAM 23, an LED driver circuit 24, a timing generator 25, the preamplifier 26, an A/D converter 27, a motor driver circuit 28, and an interface 29 are provided.

The aforesaid illumination source 14 is connected to the control circuit 21 via the LED driver circuit 24. The LED driver circuit 24 individually turns the LED of each color of the illumination source 14 on or off according to an instruction from the control circuit 21. The instruction from the control circuit 21 to the LED driver circuit 24 includes information on in what order and when the LED of each color of the illumination source 14 is to be turned on. The linear light (illumination) in the X direction is irradiated to the original 12 according to the turning-on order and the turning-on time of the LED of each color. An illumination region in the original 12 includes at least the captured area 12b (FIGS. 3A and 3B).

The above-described image sensor 17 is connected to the control circuit 21 via the timing generator 25 as well as connected to the control circuit 21 via the preamplifier 26 and the A/D converter 27.

The timing generator 25 outputs a timing signal to the image sensor 17 according to the instruction from the control circuit 21. The timing signal is a clock signal for transferring the charge accumulated in each of the photosites 41 in the rectangular region 41a of the image sensor 17.

Further, the timing generator 25 simultaneously controls the read-out gate 42 and the CCD analog shift register 43 provided to each of the two linear arrays to simultaneously output the aforesaid timing signal to each of the read-out gates 42 and the CCD analog shift registers 43.

As a result, the image sensor 17 transfers (main scan) the charge in each of the photosites 41 simultaneously from each of the two linear arrays 8a and 8b based on the timing signal from the timing generator 25, and converts it into an analog image signal to output it to the preamplifier 26. The analog image signals outputted to the preamplifier 26 include signals for two arrays, that is, a signal from the linear array 8a and a signal from the linear array 8b.

Here, transfer time TCCD of two array data in the image sensor 17 is determined by the product of the number Nx of the photosites 41 in one linear array 8a (or 8b) by a clock cycle. When the number Nx of the photosites 41 is 4000 and the clock cycle is 400 ns, the transfer time TCCD of the two array data is 1.6 ms.

The preamplifier 26 amplifies the respective analog image signals for two arrays inputted from the image sensor 17 and outputs them to the A/D converter 27. The A/D converter 27 converts the respective analog image signals for two arrays amplified in the preamplifier 26 into digital signals of a predetermined bit number (for example, 8 bits), and outputs them to the control circuit 21 as digital image data of two arrays.

The aforesaid motor 18 is connected to the control circuit 21 via the motor driver circuit 28. The motor driver circuit 28 outputs a drive pulse based on the instruction from the control circuit 21 to rotate the motor 18.

Further, the motor driver circuit 28 is capable of four-division micro-step drive. Specifically, four drive pulses can rotate the motor 18 by a unit step angle to move the scan block 19 by two arrays (2×Da in FIG. 3A) in the Y direction (sub scan).

However, timing at which the scan block 19 actually starts moving (start of two-array moving to be described later) delays, by a predetermined time, from timing at which the motor driver circuit 28 outputs the drive pulse to the motor 18. Such a delay (hereinafter referred to as “delay time TD”) is unique to a device.

Note that the control circuit 21 controls the LED driver circuit 24, the timing generator 25, and the motor driver circuit 28 described above, referring to control programs and various data stored in the ROM 22. The control programs stored in the ROM 22 include an image scanning program in which a procedure for scanning a two-dimensional image (one screen) of the original 12 is recorded.

Further, the control circuit 21 tentatively stores the digital image data for two arrays outputted from the A/D converter 27 in the RAM 23 (a line buffer) as well as sequentially outputs the digital image data for two arrays already stored in the RAM 23 to the interface 29 by parallel processing.

The interface 29 is a circuit for communicating with a host computer 30 (a high-speed I/F such as IEEE1394 or SCSI, for example), and the image scanner 10 in the first embodiment is connected to the host computer 30 via the interface 29.

The digital image data for two arrays, which is sequentially outputted from the RAM 23 to the interface 29 by the aforesaid parallel processing of the control circuit 21, is sequentially outputted from the interface 29 to a host computer 30.

Incidentally, the host computer 30 is composed of a CPU 31, a memory 32, a hard disk 33, a CD-ROM drive 34 capable of mounting a CD-ROM 36, and an interface 35. The CD-ROM 36 is a storage medium in which various programs and data are stored. Further, the host computer 30 also includes input devices such as a keyboard and a mouse, a display device, and a printer although they are not shown.

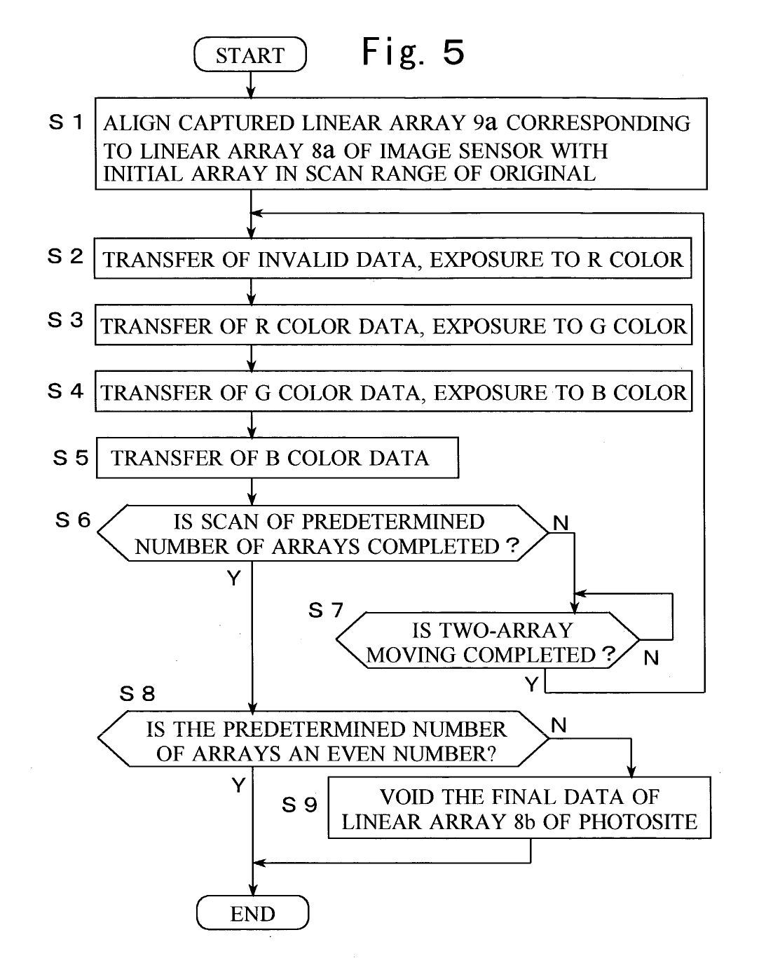

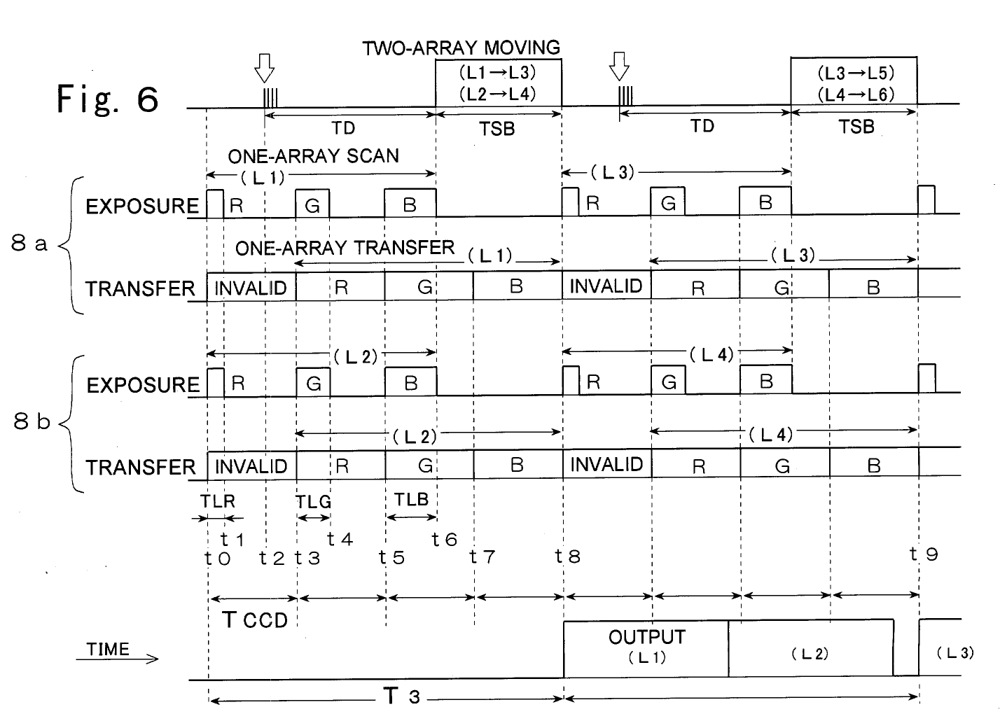

Next, the operation of the image scanner 10 having the above structure will be explained using a flow chart in FIG. 5 and a timing chart in FIG. 6.

When the image scanner 10 is powered on, the control circuit 21 initializes each part of the image scanner 10. By this initialization, the scan block 19 is placed at a predetermined reference position.

Subsequently, the control circuit 21 of the image scanner 10 stands ready for receiving a scan command from the host computer 30. A user performs a predetermined input operation to the host computer 30 to transmit the scan command from the host computer 30 to the control circuit 21 of the image scanner 10.

Upon receipt of the scan command the control section 21 of the image scanner 10 performs pre-scan according to the contents thereof (information designating a scan range of the original 12, and the like) to determine in what order and when each LED of the illumination source 14 is to be turned on. Hereinafter, the turning-on time of the red, green, and blue LEDs of the illumination source 14 is referred to as “exposure time TLR, TLG, and TLB”. In this embodiment, the scan of the two-dimensional image of the original 12 is assumed to be controlled in the order of “turning-on of the red LED (R exposure)→turning-on of the green LED (G exposure)→turning-on of the blue LED (B exposure)”.

Further, in this embodiment, the aforesaid delay time TD which occurs at the time of controlling the scan block 19 is assumed to be longer than “the exposure time TLB of the blue LED as a final color+the transfer time TCCD” and shorter than “the exposure time TLB+twice as the transfer time TCCD” (TLB+TCCD<TD<TLB+2×TCCD). In this case, a first driver pulse is outputted from the motor driver circuit 28 to the motor 18 after the exposure with the red LED, that is, before the exposure with the green LED, and the details will be described later.

As stated above, when the order of controlling the scanning of the two-dimensional image (the R exposure→the G exposure→the B exposure) and the respective exposure time TLR, TLG, and TLB are determined, the control circuit 21 performs image scanning operation according to the procedure shown in the flow chart in FIG. 5. Here, a case will be explained in which the red exposure time TLR, the green exposure time TLG, and the blue exposure time TLB are shorter than the transfer time TCCD of the image sensor 17.

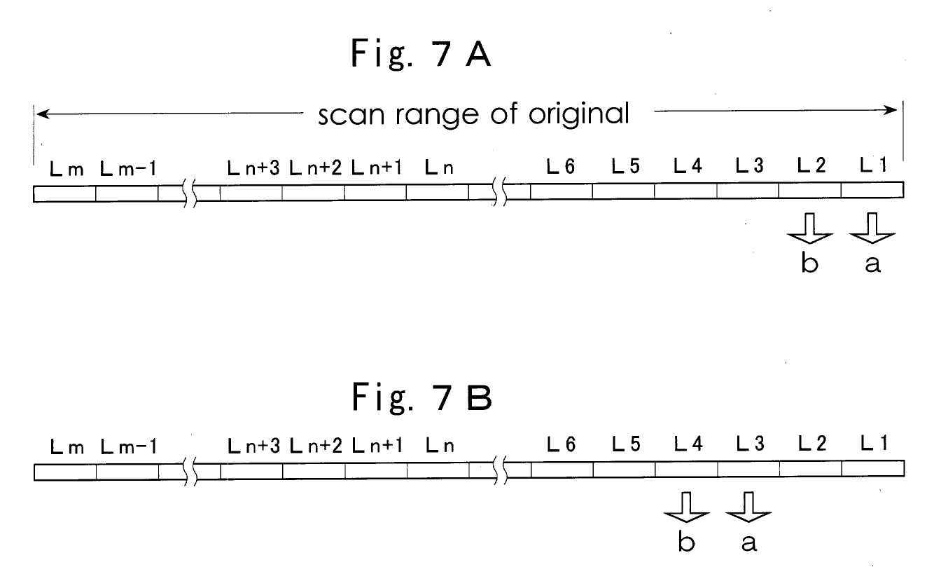

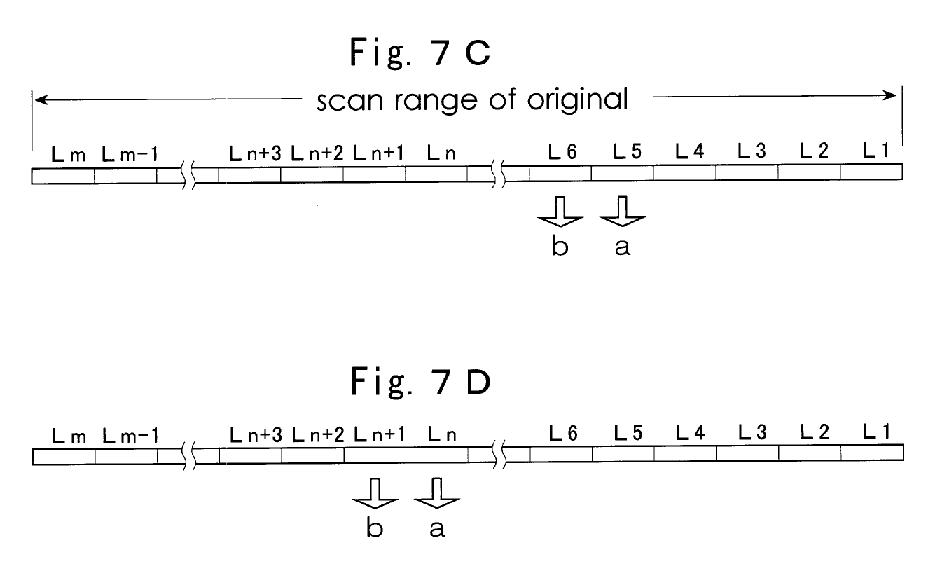

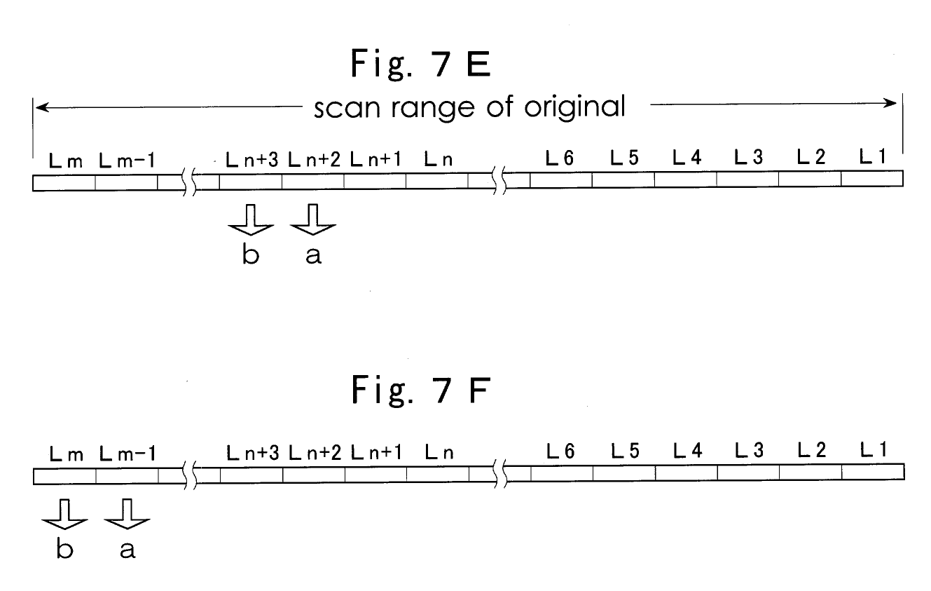

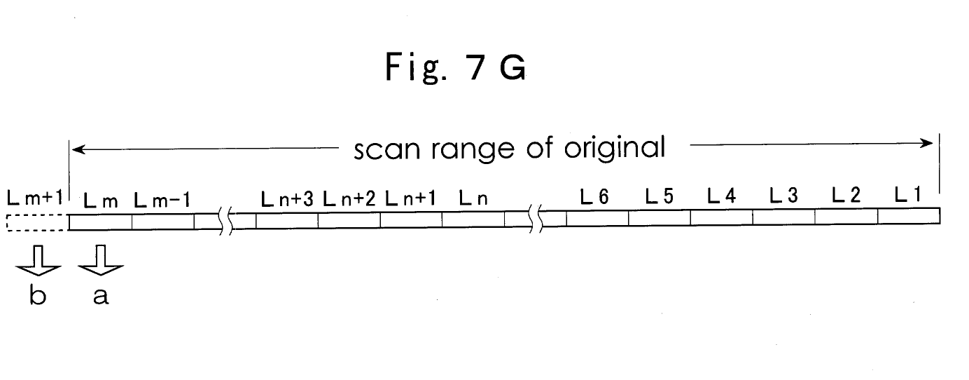

In step S1 in FIG. 5, the control circuit 21 moves the scan block 19 to a predetermined scan starting position and keeps it still. At this time, the captured linear array 9a corresponding to the linear array 8a of the image sensor 17 is aligned with the initial array (L1) in the scan range of the original 12 (a position in FIG. 7A). Further, the captured linear array 9b corresponding to the linear array 8b is aligned with the second array (L2) in the scan range.

Then, in step S2, the control circuit 21 controls the timing generator 25 to simultaneously start transfer of unnecessary charge (invalid data) accumulated in each of the photosites 41 of the two linear arrays 8a and 8b of the image sensor 17. Further, the control circuit 21 controls the LED driver circuit 24 to turn on the red LED. Time at this point is supposed to be t0 (FIG. 6).

The illumination from the red LED is simultaneously irradiated to the first and second arrays (L1 and L2) in the scan range of the original 12. Then, the R light transmitting through the first array (L1), that is, the captured linear array 9a is incident on the linear array 8a of the image sensor 17. Further, the R light transmitting through the second array (L2), that is, the captured linear array 9b is incident on the linear array 8b. The linear arrays 8a and 8b are thus exposed to an R color.

Next, when the “red exposure time TLR” has passed since the time t0 (time t1), the control circuit 21 controls the LED driver circuit 24 to turn off the red LED so as to complete the R exposure. As a result, charge (R image data) due to the R exposure is accumulated in each of the photosites 41 of the two linear arrays 8a and 8b of the image sensor 17. At this time, the read-out gates 42 and the CCD analog shift registers 43 of the image sensor 17 continues the transfer of the invalid data for two arrays.

Then, during a stand-by period from the time t0 to the completion of the transfer of the invalid data (the “transfer time TCCD” has passed since the time t0), the control circuit 21 controls the motor driver circuit 28 to output the drive pulse to the motor 18 (time t2).

The drive pulse is outputted at this timing because the actual initiation of moving of the scan block 19 delays by the delay time TD from the time when the motor driver circuit 28 outputs the drive pulse to the motor 18. The time t2 is an instant when “2×the transfer time TCCD+the blue exposure time TLB−the delay time TD” elapses since the time t0.

Further, in the first embodiment, the number of the drive pulses outputted from the motor driver circuit 28 to the motor 18 is four. This is for rotating the motor 18 by the unit step angle to move the scan block 19 by the two arrays (2×Da in FIG. 3A) in the Y direction.

When the transfer of the invalid data from the image sensor 17 is completed (the “transfer time TCCD” has passed since the time t0), the control circuit 21 goes to step S3 (time t3) and controls the timing generator 25 to simultaneously start transfer of the R image data accumulated in the linear arrays 8a and 8b. Further, the control circuit 21 controls the LED driver circuit 24 to turn on the green LED.

The illumination from the green LED is simultaneously irradiated to the first and second arrays (L1 and L2) in the scan range of the original 12. Then, the G light transmitting through the first array (L1), that is, the captured linear array 9a is incident on the linear array 8a of the image sensor 17. Further, the G light transmitting through the second array (L2), that is, the captured linear array 9b is incident on the linear array 8b. The exposure of the linear arrays 8a and 8b with a G color is thus performed.

Next, when the “green exposure time TLG” has passed since the time t3 (time t4), the control circuit 21 controls the LED driver circuit 24 to turn off the green LED so that the G exposure is completed. As a result, charge (G image data) due to the G exposure is accumulated in each of the photosites 41 of the two linear arrays 8a and 8b of the image sensor 17. At this time, the transfer part (42 and 43) of the image sensor 17 still continues the transfer of the R image data for two arrays.

Incidentally, each piece of the R image data (analog image signals) for two arrays sequentially transferred from the image sensor 17 is outputted to the control circuit 21 as digital R image data via the preamplifier 26 and the A/D converter 27 described above. Then, the control circuit 21 stores the digital R image data for two arrays received from the A/D converter 27 in the RAM 23.

Subsequently, when the transfer of the R image data for two arrays is completed (the “transfer time TCCD” has passed since the time t3), the control circuit 21 goes to step S4 (time t5) and controls the timing generator 25 to simultaneously start transfer of the G image data accumulated in the linear arrays 8a and 8b. Further, the control circuit 21 controls the LED driver circuit 24 to turn on the blue LED.

The illumination from the blue LED is simultaneously irradiated to the first and second arrays (L1 and L2) in the scan range of the original 12. Then, the B light transmitting through the first array (L1), that is, the captured linear array 9a is incident on the linear array 8a of the image sensor 17. Further, the B light transmitting through the second array (L2), that is, the captured linear array 9b is incident on the linear array 8b. The linear arrays 8a and 8b is thus exposed to a B color.

Next, when the “blue exposure time TLB” passes since the time t5 (time t6), the control circuit 21 controls the LED driver circuit 24 to turn off the blue LED so as to complete the B exposure. As a result, charge (B image data) due to the B exposure is accumulated in each of the photosites 41 of the two linear arrays 8a and 8b of the image sensor 17.

Further, this instant (the time t6) also coincides with an instant when the “delay time TD” has passed since the motor driver circuit 28 outputted the drive pulse to the motor 18 (the time t2). Therefore, simultaneously with the completion of the B exposure, the scan block 19 actually starts moving in the Y direction.

As stated above, since the number of the drive pulses to the motor 18 is four, the scan block 19 moves two arrays (2×Da in FIG. 3A) further in the Y direction (the two-array moving). The two-array moving of the scan block 19 is performed at a substantially fixed speed. Further, a time taken for the two-array moving of the scan block 19 (hereinafter referred to as “two-array moving time TSB”) is also substantially fixed.

Here, the scan block 19 starts the two-array moving from the position in which the captured linear array 9a and 9b are aligned with the first and second arrays (L1 and L2) in the scan range of the original 12 as shown in FIG. 7A to an insertion port 13 (FIG. 1A) side (L1 and L2→L3 and L4). The transfer part (42 and 43) in the image sensor 17 is still continuing the transfer of the G image data for two arrays at the time t6 (the completion of the B exposure and the start of the two-array moving of the scan block 19).

Similarly to the R image data described above, each piece of the G image data (analog image signals) for two arrays sequentially transferred from the image sensor 17 is also outputted to the control circuit 21 as digital G image data via the preamplifier 26 and the A/D converter 27. Then, the control circuit 21 stores the digital G image data for two arrays received from the A/D converter 27 in the RAM 23.

Subsequently, when the transfer of the G image data for two arrays is completed (the “transfer time TCCD” has passed since the time t5), the control circuit 21 goes to step S5 (time t7) and controls the timing generator 25 to simultaneously start transfer of the B image data accumulated in the linear arrays 8a and 8b. At this time, each of the photosites 41 of the linear arrays 8a and 8b of the image sensor 17 is in a non-exposure state. Further, the scan block 19 is in the middle of the two-array moving (L1 and L2→L3 and L4).

Similarly to the R image data and the G image data described above, each piece of the B image data (analog image signals) for two arrays sequentially transferred from the image sensor 17 is also outputted to the control circuit 21 as digital B image data via the preamplifier 26 and the A/D converter 27. Then, the control circuit 21 stores the digital B image data for two arrays received from the A/D converter 27 in the RAM 23.

Subsequently, when the transfer of the B image data for two arrays is completed (the “transfer time TCCD” has passed since the time t7), the control circuit 21 goes to step S6. At this instant, RGB scanning operations and data transfer operations on the first and second arrays (L1 and L2) in the scan range of the original 12 are completed.

As a result, the digital R image data, the digital G image data, and the digital B image data (collectively referred to as “RGB image data”) for the first and second arrays (L1 and L2) in the scan range of the original 12 are stored in the RAM 23.

Next, in step S6, the control circuit 21 judges whether or not the processing in steps S2 to S5 described above is completed for a predetermined number of arrays (corresponding to “m” in FIGS. 7A to 7G) in the scan range of the original 12.

If there is an array yet processed in the scan range of the original 12 (step S6 is N), the control circuit 21 performs processing in step S7. That is, the control circuit 21 stands by until the “two-array moving time TSB” will elapse after the aforesaid time t6 (the completion of the B exposure and the start of the two-array moving of the scan block 19).

When the “two-array moving time TSB” has passed since the time t6 (step S7 is Y), the control circuit 21 returns to the processing in step S2 (time t8). At this time, the two-array moving of the scan block 19 is completed and the scan block 19 is in a position that the captured linear array 9a and 9b are aligned with the third and fourth arrays (L3 and L4) in the scan range of the original 12 as shown in FIG. 7B.

Thereafter, the aforesaid processing in steps S2 to S5 is repeated (time t8 to t9 in FIG. 6) to perform the RGB scan and the data transfer operation on the third and fourth arrays (L3 and L4) in the scan range of the original 12. Further, after the completion of the B exposure, the scan block 19 is moved by two arrays (L3 and L4 L5 and L6), to be in a position in which the captured linear array 9a and 9b are aligned with the fifth and sixth arrays (L5 and L6) in the scan range of the original 12 (FIG. 7C).

In this scan cycle (the time t8 to t9 in FIG. 6), the RGB image data for the third and fourth arrays (L3 and L4) in the scan range of the original 12 is stored in the RAM 23.

Moreover, in this scan cycle (the time t8 to t9 in FIG. 6), the RGB image data for the first and second arrays (L1 and L2) stored in the RAM 23 in the previous scan cycle (the time t0 to t8 in FIG. 6) is subjected to the parallel processing of the control circuit 21 and outputted to the host computer 30 (PC) via the interface 29. Note that using the high-speed I/F such as IEEE1394 as the interface 29 makes it possible to complete the output of the aforesaid RGB image data for two arrays to the host computer 30 within time T3 (=TCCD+TCCD+TLB+TSB) which is a required length of time for one cycle of processings (steps S2 to S7) (the time t8 to t9).

In the image scanner 10 of this embodiment as described above, repeating the processing of steps S2 to S7 on every two arrays makes it possible to sequentially perform the scanning and data transfer of the two-dimensional image (one screen) of the original 12 including the three colors of red (R), green (G), and blue (B).

In general, the RGB scan and the data transfer operation for the nth array and the n+1th array in the scan range of the original 12 are performed in a position of FIG. 7D, and then the scan block 19 moves by two arrays, and the RGB scan and the data transfer operation for the n+2th array and the n+3th array are performed in a position of FIG. 7E. It should be noted that the nth array and the n+2th array are scanned using the linear array 8a of the image sensor 17 and the n+1th array and the n+3th array are scanned using the linear array 8b.

Further, the RGB image data for the nth array and the n+1th array, which is scanned in the position of FIG. 7D and stored in the RAM 23, is subjected to the parallel processing of the control circuit 21 and outputted to the host computer 30 within the time T3 equal to required for one cycle of the processings in the next scan cycle (when scan is performed in the position of FIG. 7E).

Then, when the processing in the aforesaid steps S2 to S5 (FIG. 5) is completed for the predetermined number m of arrays in the scan range of the original 12 (step S6 is Y), the control circuit 21 outputs the RGB image data for the two arrays stored in the RAM 23 at this stage to the host computer 30.

Next, the host computer 30 judges whether the predetermined number m of arrays in the scan range of the original 12 is an even number or an odd number in step S8.

When the predetermined number m of arrays in the scan range is an even number (S8 is Y), that means that the linear array 8b of the image sensor 17 scans the final array (Lm) in the scan range (a position of FIG. 7F), the host computer judges the RGB image data for two arrays inputted last from the image scanner 10 (data on the m−1th array and the mth array) as valid data, and completes the processing.

On the other hand, when the predetermined number m of arrays is an odd number (S8 is N), that means the linear array 8a of tie image sensor 17 scans the final array (Lm) in the scan range (a position of FIG. 7G), an array scanned last by the other linear array 8b is the m+1th array which is outside the scan range.

Therefore, in step S9, the host computer 30 voids the RGB image data on the m+1th array (the final data scanned by the linear array 8b) out of the RGB image data for the two arrays inputted last from the image scanner 10 (data on the mth array and the m+1th array), and judges only the RGB image data on the mth array as valid and completes the processing.

Here, a time (total scan time Ta of one screen) required for scanning the scan range (the total number of arrays is m) of the original 12 is determined by a product of the time T3 (=TCCD+TCCD+TLB+TSB) taken for one cycle (S2 to S7) described above and the number of repetition times Ns of the scanning (Ta=T3×Ns).

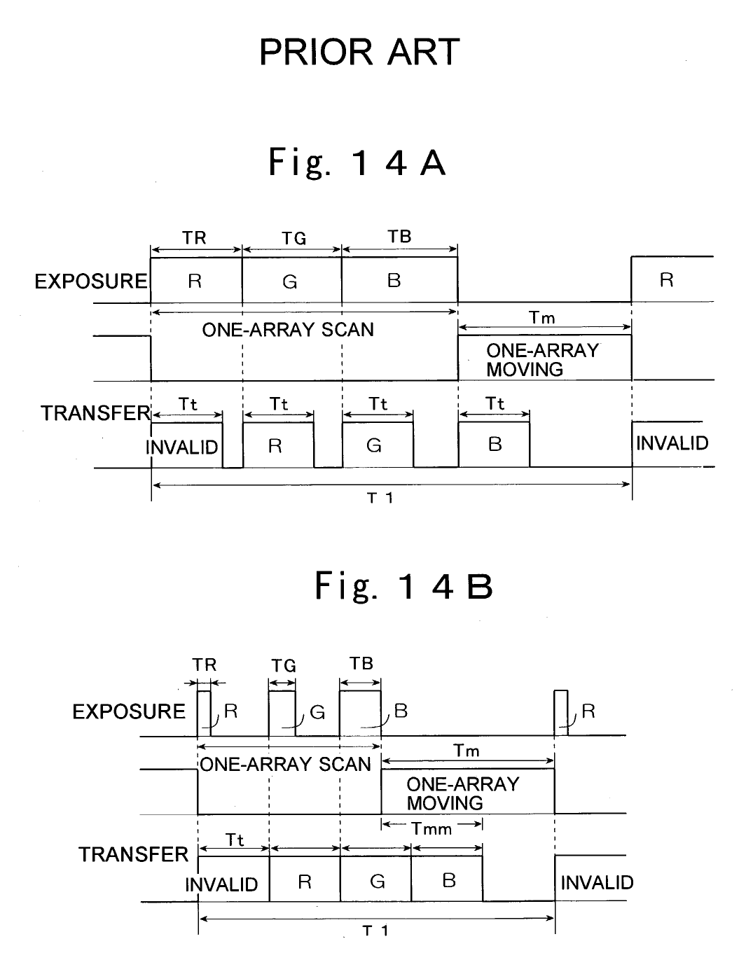

For example, when the number Nx of the photosites 41 in one linear array a (or b) is 4000 and the clock cycle is 400 ns (a 4000 dpi class is assumed), the time T3 required for one cycle (S2 to S7) is T3=TCCD×4=4000×400 ns×4=6.4 ms at the shortest. This is equivalent to the shortest required time T1 of the prior art (FIG. 14B). Incidentally, the time (TSB) for two-array moving of the scan block 19 is substantially the same as time (Tm) for conventional one-array moving.

However, the image scanner 10 of the first embodiment performs the scan processings (S2 to S7) of the two-dimensional image (one screen) of the original 12 on every two arrays. Specifically, the RGB image data for two arrays is simultaneously obtained using the image sensor 17 (FIGS. 2A to 2C) having two linear arrays 8a and 8b, and performs two-array moving of the scan block 19 (FIGS. 7A to 7G).

Accordingly, the number of repetition times Ns in scanning the scan range (the total number of arrays is m) of the original 12 is m/2 (m is the even number) or (m+1)/2 (m is the odd number). In other words, the number of repetition times Ns of the scan cycle (S2 to S7) in the image scanner 10 is approximately a half of the number of repetition times of the prior art (=m).

Therefore, in the image scanner 10 of the first embodiment, the time (the total scan time of the one screen Ta=T3×Ns) required for scanning the scan range (the total number of arrays is m) of the original 12 can be also shortened to approximately a half as compared with conventional scan time (=T1×m).

For example, when a 35 mm film (24 mm×36 mm) is scanned by the 4000 dpi class, the total number m of arrays of the scan range (one screen) of the original 12 is 6000, and the total scan time Ta of the scan range (one screen) in the image scanner 10 of the first embodiment is 6.4 ms×6000/2=19.2 seconds.

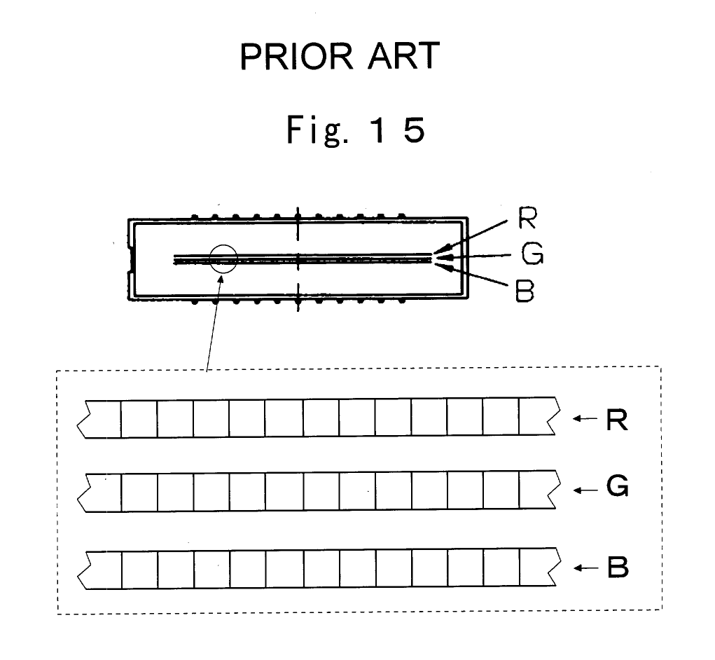

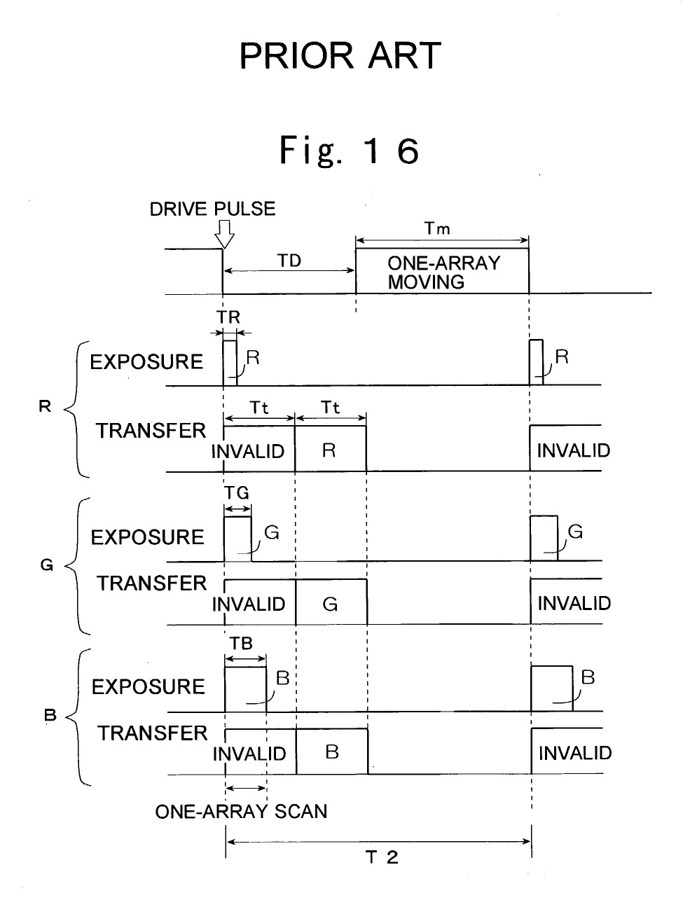

On the other hand, the conventional scan time (=T1×m) is 38.4 seconds. Further, the total scan time is approximately 38 seconds when a conventional color three-array sensor (FIG. 15) is used. Compared with these conventional devices, it is understood that the image scanner 10 of the first embodiment can substantially shorten the total scan time Ta of the one screen (by approximately 19 seconds).

(Second Embodiment)

Hereinafter, multi sample scanning, which is performed when a color image of the original 12 is scanned using the above-described image scanner 10 (FIG. 1A to FIG. 4) in the first embodiment, will be explained. The explanations of the image scanner 10 (FIG. 1A to FIG. 4) are omitted here.

The multi sample scanning is a method in which the same array in the scan range of the original 12 is scanned n times for taking the average, which reducing image noise to 1/(√n). For example, when the same array is scanned twice to get the average, the image noise can be reduced to 1/(√2).

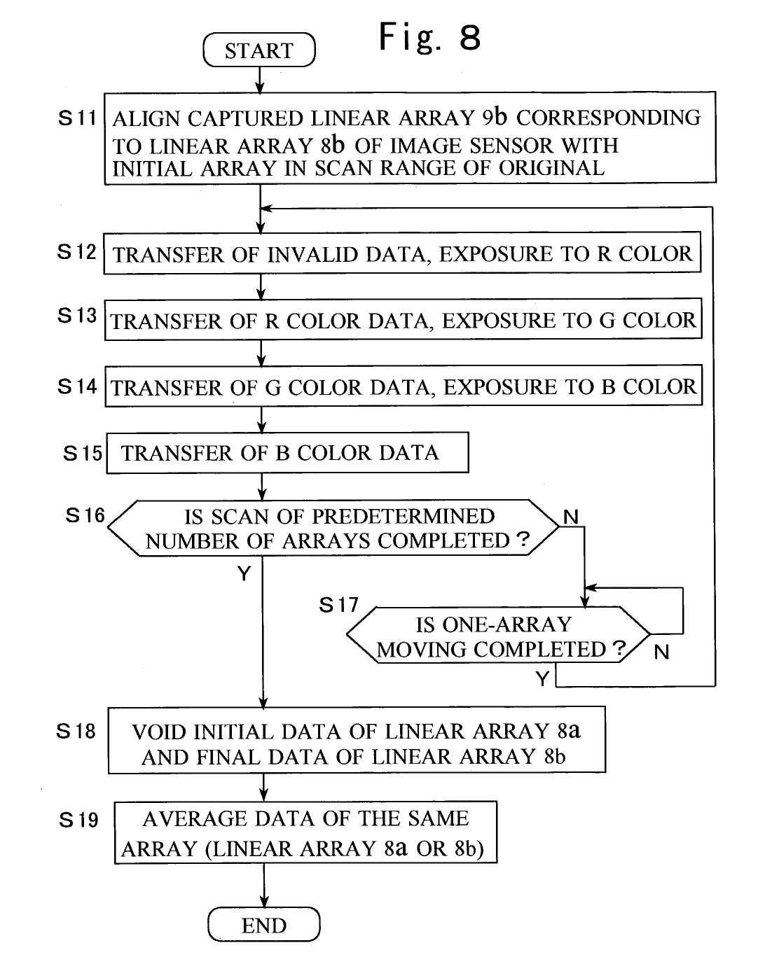

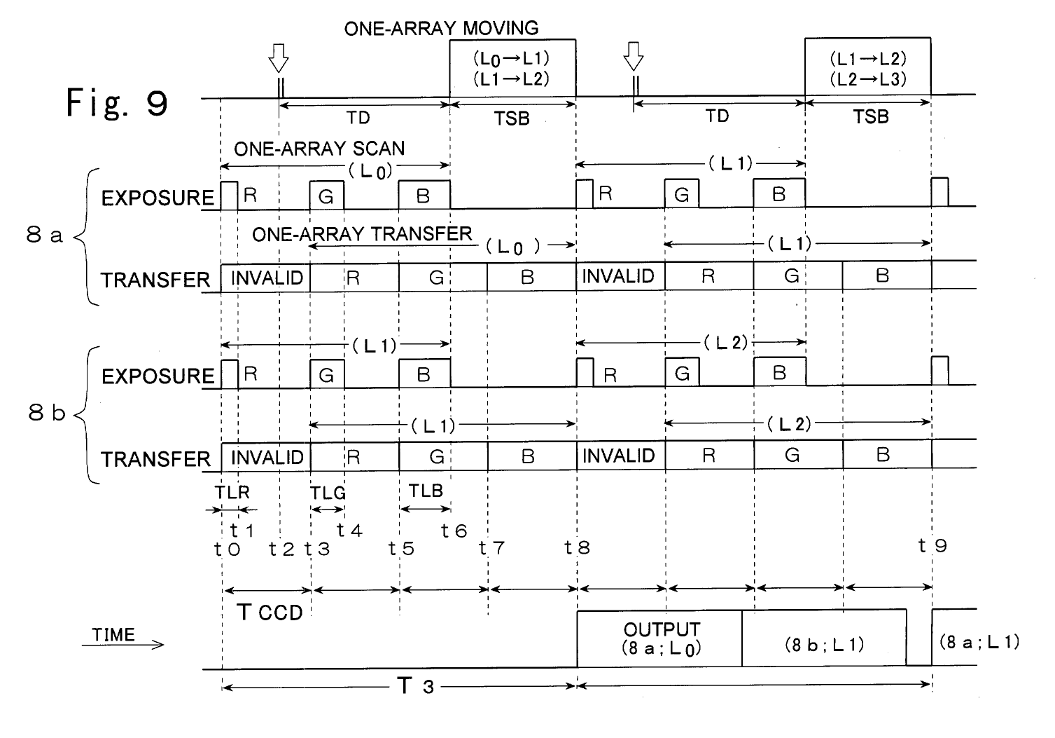

Meanwhile, the operation of the image scanner 10 for realizing the multi sample scanning in a second embodiment will be explained using a flow chart in FIG. 8 and a timing chart in FIG. 9.

Upon power-on of the image scanner 10 and receipt of the scan command from the host computer 30, the control section 21 performs pre-scan based on the contents of the command (information designating the scan range of the original 12, and the like) to determine in what order the scanning control (the R exposure→the G exposure→the B exposure) of the two-dimensional image is performed and their respective exposure time TLR, TLG, and TLB (<the transfer time TCCD). After the determination, the control circuit 21 performs the image scanning operation according to the procedure shown in the flow chart in FIG. 5.

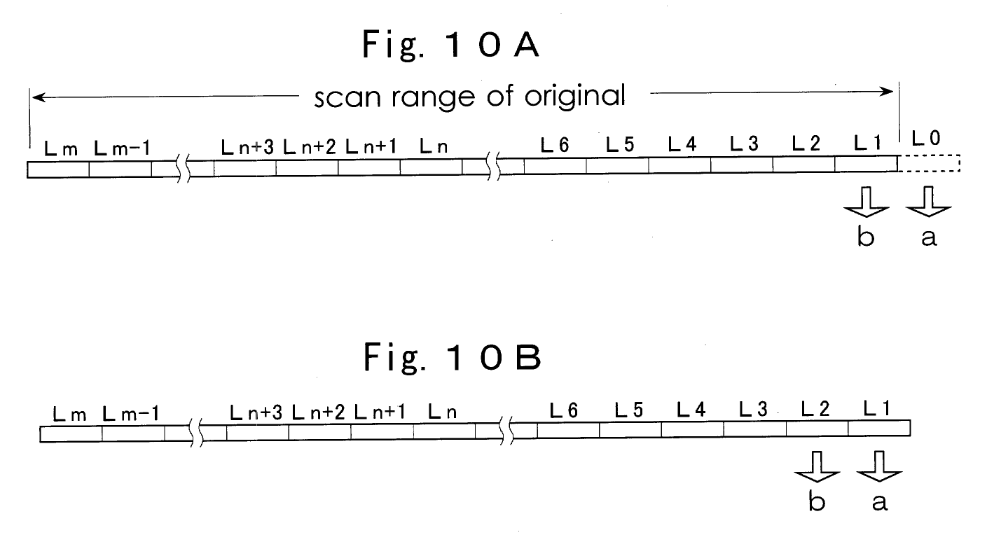

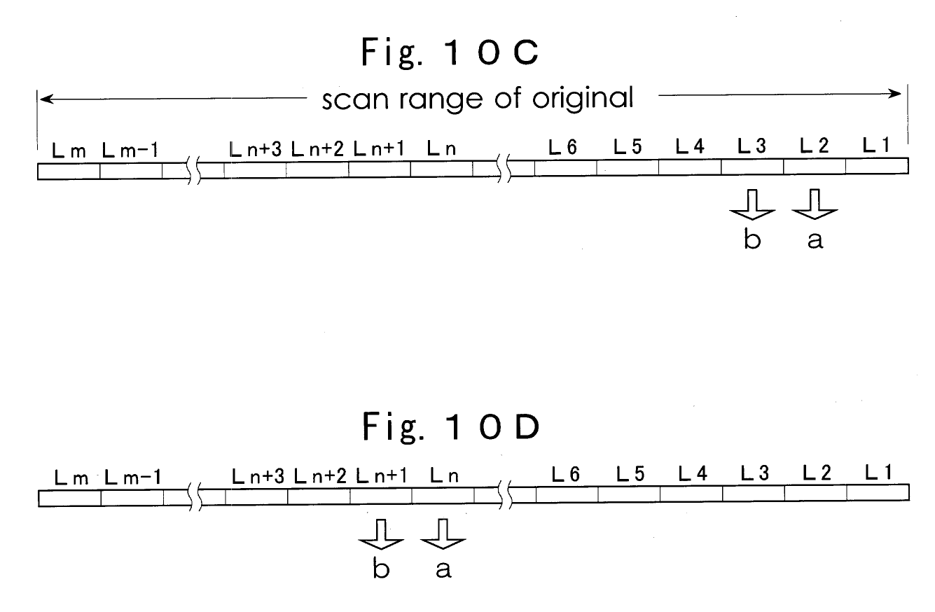

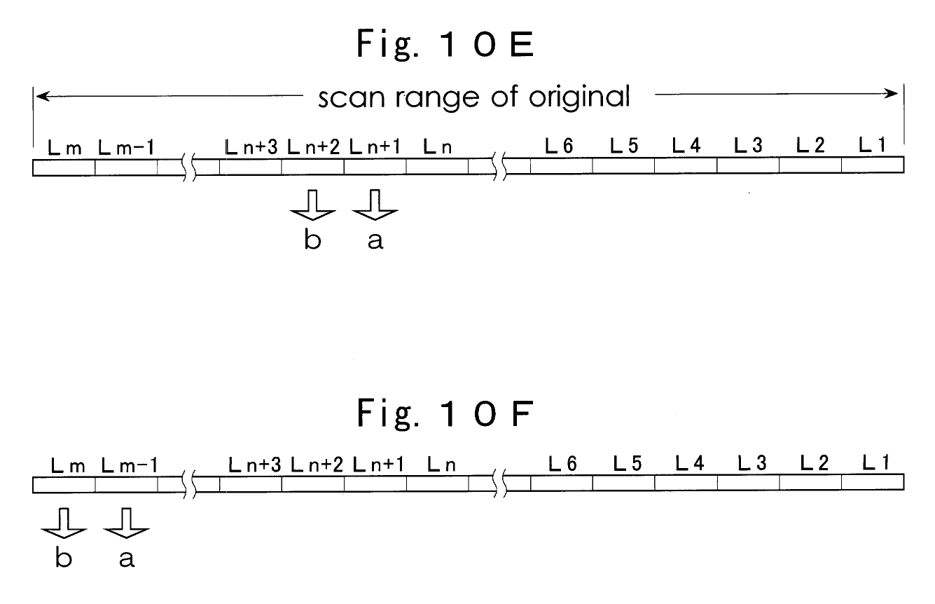

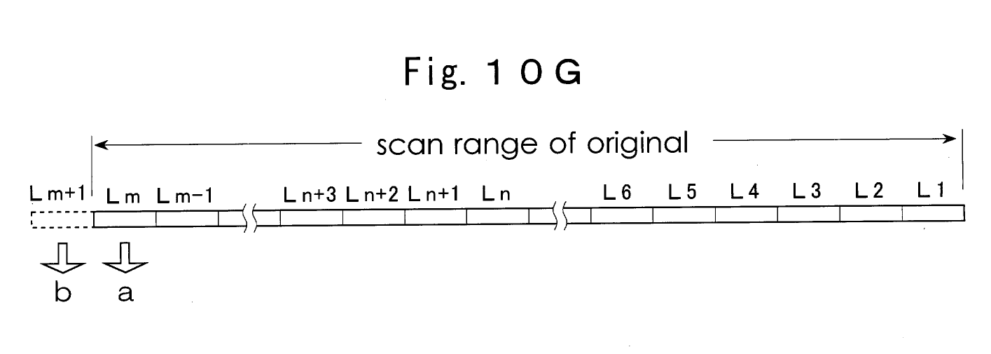

In step S11 in FIG. 8, the control circuit 21 moves the scan block 19 to the predetermined scan start position and keeps it still. At this time, the captured linear array 9b corresponding to the linear array 8b of the image sensor 17 is aligned with the initial array (L1) in the scan range of the original 12 (a position of FIG. 10A). Further, the captured linear array 9a corresponding to the linear array 8a is aligned with the 0th array (L0) outside the scan range.

In subsequent step S12, invalid data is simultaneously transferred from the two linear arrays 8a and 8b of the image sensor 17, and the red LED is turned on (time t0 in FIG. 9). The illumination from the red LED is simultaneously irradiated to the 0th and first arrays (L0 and L1) of the original 12.

Then, when the “red exposure time TLR” passes since the time to (time t1), the red LED is turned off and the R exposure is completed. As a result, the R image data is accumulated in the two linear arrays 8a and 8b of the image sensor 17.

On the other hand, during a stand-by period taken for completion of the transfer of the invalid data (the “transfer time TCCD” has passed since the time t0), the control circuit 21 controls the motor driver circuit 28 to output the drive pulse to the motor 18 (time t2). At this time, the number of the drive pulses outputted from the motor driver circuit 28 to the motor 18 is two. This is for rotating the motor 18 by a half of the unit step angle to move the scan block 19 by one array (Da in FIG. 3A) in the Y direction.

When the transfer of the invalid data from the image sensor 17 is completed (the “transfer time TCCD” has passed since the time t0), the control circuit 21 goes to step S13 (time t3) and simultaneously starts transfer of the R image data accumulated in the linear arrays 8a and 8b. Further, the control circuit 21 turns on the green LED. The illumination from the green LED is simultaneously irradiated to the 0th and first arrays (L0 and L1) of the original 12.

Next, when the “green exposure time TLG” passes since the time t3 (time t4), the control circuit 21 turns off the green LED so that the G exposure is completed. As a result, the G image data is accumulated in the two linear arrays 8a and 8b of the image sensor 17. Each piece of the R image data for two arrays transferred from the image sensor 17 in this step S13 is outputted to the control circuit 21 as the digital R image data and stored in the RAM 23.

Then, when the transfer of the R image data for two arrays is completed (the “transfer time TCCD” has passed since the time t3), the control circuit 21 goes to step S14 (time t5) and simultaneously starts transfer of the G image data accumulated in the linear arrays 8a and 8b. Further, the control circuit 21 turns on the blue LED. The illumination from the blue LED is simultaneously irradiated to the 0th and first arrays (L0 and L1) of the original 12.

Subsequently, when the “blue exposure time TLB” passes since the time t5 (time t6), the control circuit 21 turns off the blue LED so that the B exposure is completed. As a result, the B image data is accumulated in the two linear arrays 8a and 8b of the image sensor 17.

In addition, this instant (the time t6) also coincides with an instant when the “delay time TD” has passed since the motor driver circuit 28 outputted the drive pulse to the motor 18 (the time t2). Therefore, simultaneously with the completion of the B exposure, the scan block 19 actually starts moving in the Y direction. As stated above, since the number of the drive pulses to the motor 18 is two, the scan block 19 moves by one array (Da in FIG. 3A) in the Y direction (the one-array moving). A time taken for moving the scan block 19 by one array (hereinafter referred to as “one-array moving time TSB”) is substantially fixed.

Here, the scan block 19 starts the one-array moving from a position in which the captured linear array 9a and 9b are aligned with the 0th and first arrays (L0 and L1) of the original 12 as shown in FIG. 10A to the insertion port 13 (FIG. 1A) side (L0 and L1→L1 and L2).

At the time t6 (at which the B exposure has been complete and the one-array moving of the scan block 19 has started), the transfer part (42 and 43) in the image sensor 17 still continues the transfer of the G image data for two arrays. Each piece of the G image data for two arrays transferred from the image sensor 17 in this step S14 is also outputted to the control circuit 21 as the digital G image data and stored in the RAM 23.

Then, when the transfer of the G image data for two arrays is completed (the “transfer time TCCD” has passed since the time t5), the control circuit 21 goes to step S15 (time t7) and simultaneously starts transfer of the B image data accumulated in the linear arrays 8a and 8b. At this time, the scan block 19 is in the middle of the one-array moving (L0 and L1→L1 and L2). Each piece of the B image data for two arrays transferred from the image sensor 17 in this step S15 is also outputted to the control circuit 21 as the digital B image data and stored in the RAM 23.

Next, when the transfer of the B image data for two arrays is completed (the “transfer time TCCD” has passed since the time t7), the control circuit 21 goes to step S16. At this instant, RGB scanning operations and data transfer operations of the 0th and first arrays (L0 and L1) of the original 12 are completed. On this occasion, the RGB image data for the 0th and first arrays (L0 and L1) of the original 12 is stored in the RAM 23.

Subsequently, in step S16, the control circuit 21 judges whether or not the processing in steps S12 to S15 described above on a predetermined number of arrays is completed (corresponding to “m” in FIGS. 10A to 10G) in the scan range of the original 12. Then, when there is an array yet processed in the scan range of the original 12 (step S16 is N), the control circuit 21 stands by until the “one-array moving time TSB” will pass from the aforesaid time t6 (the completion of the B exposure and the start of the one-array moving of the scan block 19) in step S17, and thereafter returns to the processing in step S12 (time t8).

At this time, the one-array moving of the scan block 19 is completed and the scan block 19 is in a position in which the captured linear array 9a and 9b are aligned with the first and second arrays (L1 and L2) in the scan range of the original 12 as shown in FIG. 10B.

Thereafter, the aforesaid processing in steps S12 to S15 is repeated (time t8 to t9 in FIG. 9) to perform the RGB scan and the data transfer operation for the first and second arrays (L1 and L2) in the scan range of the original 12. Further, after the completion of the B exposure, the scan block 19 moves by one array (L1 and L2→L2 and L3) to be in a position in which the captured linear array 9a and 9b are aligned with the second and third arrays (L2 and L3) in the scan range of the original 12 (FIG. 10C).

In this scan cycle (the time t8 to t9 in FIG. 9), the RGB image data for the first and second arrays (L1 and L2) in the scan range of the original 12 is stored in the RAM 23.

Further, in this scan cycle (the time t8 to t9 in FIG. 9), the RGB image data for the 0th and first arrays (L0 and L1) stored in the RAM 23 in the previous scan cycle (the time t0 to t8 in FIG. 9) is subjected to the parallel processing of the control circuit 21 and outputted to the host computer 30 within time T3 (=TCCD+TCCD+TLB+TSB) required for one cycle (steps S12 to S17).

As described above, also in the second embodiment, the processing in steps S12 to S17 is repeated on every two arrays so as to sequentially perform the scan of the two-dimensional image (one screen) of the original 12 using the three colors of red (R), green (G), and blue (B) and the data transfer.

In general, the RGB scan and the data transfer operation for the nth array and the n+1th array in the scan range of the original 12 are performed in a position in FIG. 10D, and then the scan block 19 moves by one array, and thereafter the RGB scan and the data transfer operation for the n+1th array and the n+2th array are performed in a position in FIG. 10E. Incidentally, the n+1th array is scanned in the position in FIG. 10D by the linear array 8b and scanned in the position in FIG. 10E by the linear array 8a.

Further, the nth array and the n+1th array are scanned in the position in FIG. 10D and the RGB image data therefor is stored in the RAM 23 and outputted to the host computer 30 within the time T3 required for one cycle in the next scan cycle (when scan is performed in the position in FIG. 10E).

Then, when the processing in the aforesaid steps S12 to S15 (FIG. 8) is completed for the predetermined number m of arrays in the scan range of the original 12 and the same array in the scan range is scanned twice (step S16 is Y), the control circuit 21 outputs the RGB image data (data scanned in the position in FIG. 10G) for two arrays stored in the RAM 23 at this point to the host computer 30.

Next, the host computer 30 voids the RGB image data related to the 0th array (the initial data scanned in the position in FIG. 10A by the linear array 8a) and the RGB image data related to the m+1th array (the final data scanned in the position in FIG. 10G by the linear array 8b) being outside the scan range of the original 12 in step S18.

Finally, the host computer 30 averages, for the initial array (L1) to the final array (Lm) in the scan range of the original 12, the RGB image data obtained by the linear array 8a and the RGB image data obtained by the linear array 8b, and completes the processing.

As stated above, according to the multi sample scanning of the second embodiment, the same array in the scan range of the original 12 is scanned twice for calculating the average so that the image noise can be reduced to 1/(√2).

Further, time (total scan time Tb of one screen) required for scanning the scan range (the total number of arrays is m) of the original 12 is determined by a product of the time T3 (=TCCD+TCCD+TLB+TSB) required for one cycle (S12 to S17 in FIG. 8) described above and the number of repetition times Ns of the scanning (Tb=T3×Ns).

The time T3 required for one cycle (S12 to S17) is the same (6.4 ms at shortest) as in the aforesaid first embodiment (FIG. 6), and is also the same as the conventional shortest required time T1 (FIG. 14B). Further, the number of repetition times Ns of scanning the scan range (the total number of arrays is m) of the original 12 is (m+1).

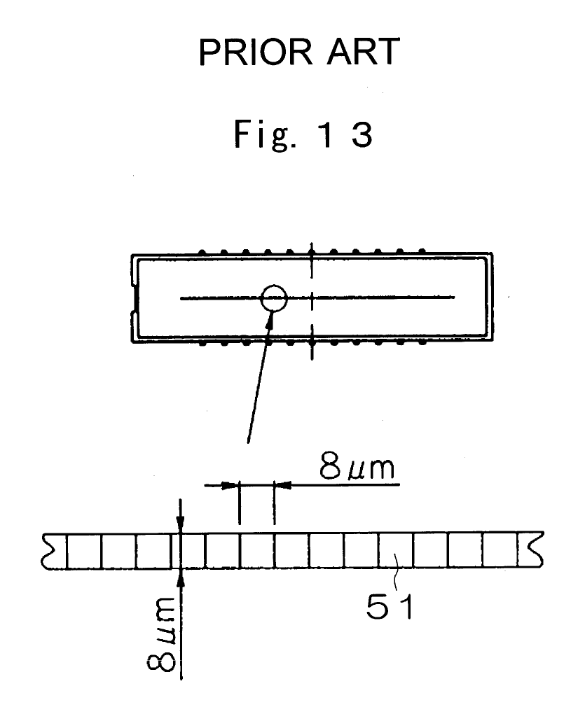

Here, if the multi sample scanning is performed, using a conventional monochrome one-array sensor (FIG. 13), to scan the same array in the scan range (the total number of arrays is m) of the original 12 twice, the number of scanning repetition times will be (2×m).

On the other hand, in the second embodiment, the scan cycle (S12 to S17) of two-dimensional image (one screen) of the original 12 is performed in a unit of two arrays. Specifically, the RGB image data for two arrays is simultaneously obtained using the image sensor 17 (FIGS. 2A to 2C) having the two linear arrays 8a and 8b, and further the scan block 19 moves by one array (FIGS. 10A to 10G), so that the number of repetition times Ns (=m+1) can be reduced to approximately a half of the number of conventional repetition times (=2×m). Therefore, in the multi sample scanning of the second embodiment, the time (the total scan time of one screen Tb=T3×Ns) required for scanning the scan range (the total number of arrays is m) of the original 12 can be also shortened to approximately a half compared with scan time of conventional multi sample scanning (=T1×2×m).

In other words, it is possible to obtain a multi sample scanning image of high quality with the noise reduction (S/N improvement) within approximately a half of the scan time of the conventional multi sample scanning.

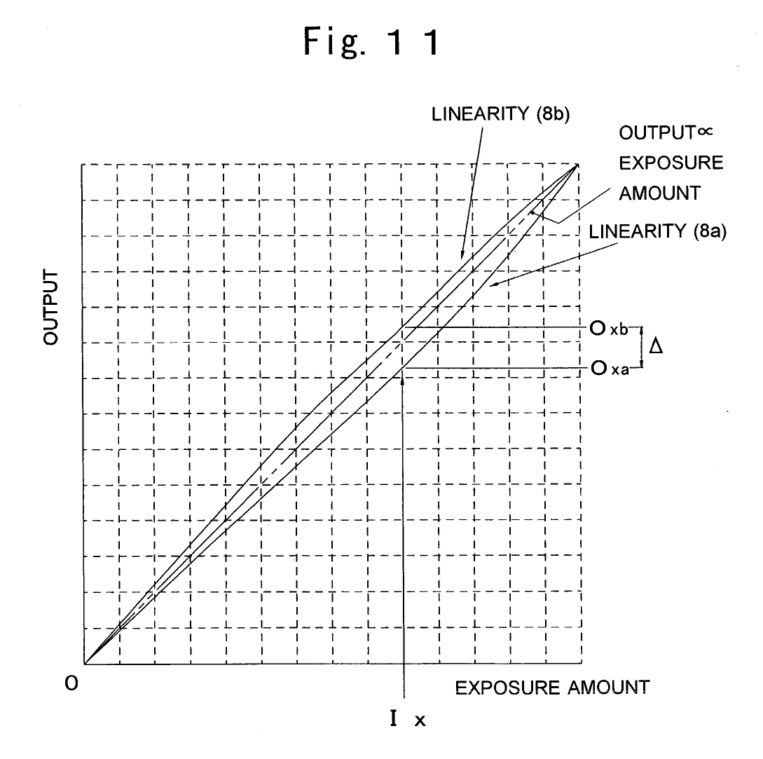

Incidentally, when output characteristics of the two linear arrays 8a and 8b are compared with regard to an exposure amount of the image sensor 17 (FIGS. 2A to 2C), their output characteristics are slightly different from each other in some cases as shown in FIG. 11. Specifically, even if the image sensor has the same exposure amount value (lx), there sometimes occurs a case in which output (Oxa) of the linear array 8a and output (Oxb) of the linear array 8b do not coincide, producing an output difference (Δ).

In the multi sample scanning of the second embodiment, however, the same array in the scan range of the original 12 is scanned once by each of the linear arrays 8a and 8b of the image sensor 17 and the RGB image data obtained by the linear array 8a and the RGB image data obtained by the linear array 8b are averaged so that such output difference (Δ) can be eliminated even if there occurs the output difference (Δ) between the output characteristics of the linear arrays 8a and 8b as shown in FIG. 11.

It should be noted that, although the scan cycle (S12 to S17 in FIG. 8) is performed once in various positions of the scan block 19 (FIGS. 10A to 10G) in the second embodiment described above, the present invention is not limited to thereto. For example, the scan cycle is repeated twice in each of the positions of the scan block 19 (FIGS. 10A to 10G) so that the same array can be scanned four times. Then, the obtained data for the four scannings is averaged, which can reduce the noise to a half. Also in this case, the scan time can be shortened to approximately a half compared with the conventional multi sample scanning (four times).

Further, the processings of voiding of the invalid data (S18) and averaging the valid data (S19) are performed collectively after the image scanner 10 completes the scanning operation (steps S11 to S17 in FIG. 8) in the second embodiment described above, but the voiding of the invalid data and the averaging of the valid data may be performed in parallel for each of the data inputted from the image scanner 10 to the host computer 30.

In the first and second embodiments described above, since the motor driver circuit 28 capable of four-division micro-step drive is used as a driving device of the motor 18 for step-moving the scan block 19 in the Y direction (the sub-scan direction), it is possible to perform both normal scanning (FIG. 5 to FIG. 7G) in the first embodiment and the multi sample scanning (FIG. 8 to FIG. 10G) in the second embodiment by controlling the number of the drive pulses outputted from the motor driver circuit 28 to the motor 18.

Accordingly, by including information on scan modes (normal scanning and multi sample scanning) of the two-dimensional image of the original 12 in the scan command transmitted from the host computer 30 to the image scanner 10, it is possible to control the number (four and two) of the drive pulses according to the scan mode to change a step-moving distance (2×Da and Da in FIG. 3A) of the scan block 19 in the image scanner 10. This realizes scanning according to the scan mode included in the scan command.

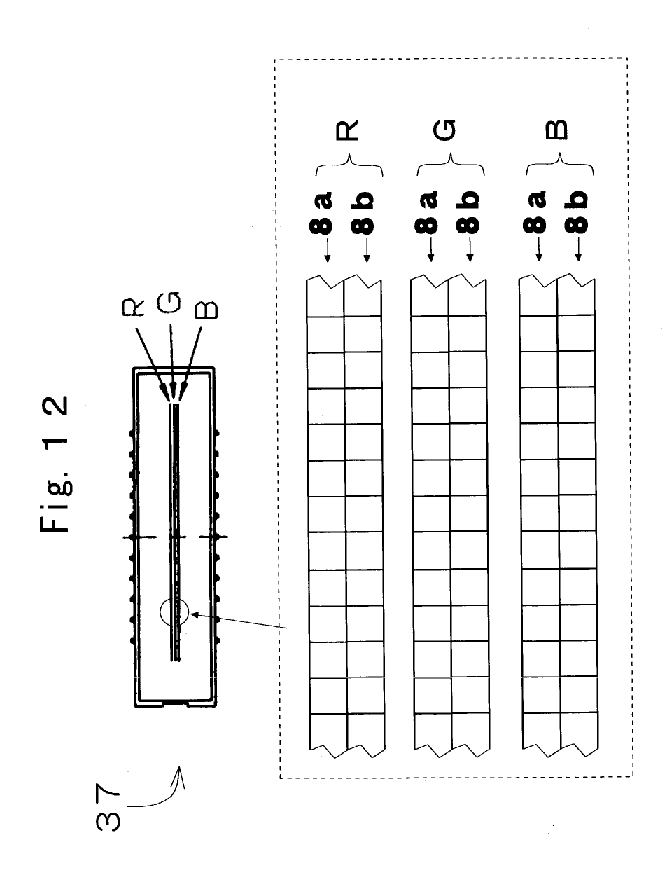

Further, the first and second embodiments have described an example of the image scanner 10, in which the image sensor 17 is composed of a monochrome image sensor (the two linear array 8a and 8b) and in which color separation of RGB is performed by switching light emission of the illumination source 14 so as to scan the color image of the original 12, but the present invention is not limited to thereto. For example, a color image sensor 37 shown in FIG. 12 can be used in place of the above structure. In this color image sensor, each of an R array, a G array, and a B array is composed of two linear arrays of photosites 8a and 8b. Note that the R array, the G array, and the B array are not close and separate from each other by several arrays.

In an image scanner using this color image sensor 37, similarly to the image scanner 10 using the aforesaid monochrome image sensor (the two linear arrays 8a and 8b), the color image of one screen of the original 12 can be scanned in approximately a half of the conventional scan time. Further, it is also possible to obtain the multi sample scanning image of high quality with the noise reduction (S/N improvement) within approximately a half of the scan time of the conventional multi sample scanning.

Furthermore, the image sensors 17 and 37 in which the two linear arrays 8a and 8b are closely arranged are explained as examples in the first and second embodiments described above, but the present invention can be also applied to an image sensor in which three or more linear arrays of photosites are closely arranged.

As the number of the close linear arrays of photosites is increased, the number of scanning repetition times Ns for the scan range of the original 12 can be reduced, and as a result of this, the total scan time of one screen of the original 12 can be shortened.

However, the increase in the number of the adjacent linear arrays of photosites increases the manufacturing costs of the image sensor and of the RAM (the line buffer) so that the most preferable number of the linear arrays of photosites is two. The two adjacent linear arrays of photosites realize high-speed scanning with the costs prevented from increasing.

Further, the first and second embodiments have described an example in which the three colors of red (R), green (G), and blue (B) are used to scan the two-dimensional image of the original 12, the present invention can be also applied to a case in which the two-dimensional image is scanned using two colors or four colors or more. Furthermore, the similar effect can be attained not only by scanning the color image of the original 12 but also by scanning a monochrome image thereof. Moreover, the similar effect can be obtained also in a case in which the illumination exposure time is equal to or longer than the transfer time TCCD of the image sensor.

In addition, the first and second embodiments have described an example of scanning the two-dimensional image of the original 12 held by a slide mount, but it is also possible to scan an original held by a film holder and a strip film in a short time. The present invention is not limited to the scanning of the transparent original (the original 12) and also applicable to the scanning of a reflective original (paper, for example).

Further, the first and second embodiments have described an example in which the scanning system (14 to 17) moves in the sub-scan direction together with the scan block 19 relative to the fixed original 12, however, the scanning system (14 to 17) may be fixed and the original 12 may be moved in the sub-scan direction instead. Furthermore, the original 12 and the scanning system (14 to 17) may be relatively moved in the sub-scan direction.

Moreover, the original 12 is illuminated by the linear illumination including at least the captured area 12b (FIGS. 3A and B) in the first and second embodiments described above, but the present invention can be also applied to the structure in which the entire scan range of the original 12 is illuminated (area illumination).

In addition, although the above embodiments have described as an example the case in which the delay time TD of the scan block 19 satisfies a condition “TLB+TCCD<TD<TLB+2×TCCD”, the present invention is applicable irrespective of the delay time TD of the scan block 19.

Further, the above embodiments have described an example in which the image scanning program which the control circuit 21 of the image scanner 10 performs is stored in the ROM 22, but the image scanning program may be stored in the hard disk 33 of the host computer 30 externally connected via the interface 29. Furthermore, in place of the control circuit 21 of the image scanner 10, various control may be performed using the CPU 31 of the host computer 30.

When the various control is performed according to the image scanning program stored in the hard disk 33 of the host computer 30, a computer-readable storage medium (the CD-ROM 34, for example) in which a necessary image scanning program is stored can be used by installing the image scanning program from the storage medium to the hard disk 33 prior to the control.

Moreover, it is also desirable to use an image scanning program (a driver software or a firmware) which is downloaded to the hard disk 33 by accessing a homepage via the Internet from a terminal such as the host computer 30. It can be downloaded by, for example, accessing the homepage from the terminal to select (clicking) an image scanner among products displayed on a screen and to further select the driver software or the firmware suitable for an OS environment of the terminal. The terminal and the Internet are connected through a dial-up connection, a connection using a private line between a provider and the terminal, or the like.

In addition, the memory 32 and the hard disk 33 of the host computer 30 may be used in place of the RAM 23 of the image scanner 10. As the interface 29 between the image scanner 10 and the host computer 30, not only IEEE1394 and the SCSI interface but also other interfaces (such as USB or parallel) may be used.

The invention is not limited to the above embodiments and various modifications may be made without departing from the spirit and scope of the invention. Any improvement may be made in part or all of the components.

What is claimed is:

1. A solid state image sensor, comprising:
two or more linear arrays of photosites in which a plurality of photosites are closely and one-dimensionally arranged in one direction, the plurality of photosites being for accumulating charge in accordance with incident light; and
transfer parts provided for said two or more linear arrays of photosites respectively, for transferring, array by array, the charge accumulated in each of the photosites of said two or more linear arrays, wherein
said two or more linear arrays are closely arranged in a rectangular region in a direction perpendicular to said one direction, the rectangular region being long in said one direction.

2. An image scanner, comprising:
an illuminating section for irradiating illumination to an original;
a solid state image sensor including; two or more linear arrays of photosites in which a plurality of photosites are closely and one-dimensionally arranged in one direction, the plurality of photosites being for accumulating charge in accordance with light from the illuminated original; and transfer parts provided for said two or more linear arrays of photosites respectively, for transferring, array by array, the charge accumulated in each of the photosites of said two or more linear arrays, in which said two or more linear arrays of photosites are closely arranged in a rectangular region in a direction perpendicular to said one direction, the rectangular region being long in said one direction;
a moving section for relatively moving a captured area and said original in a sub-scan direction corresponding to said perpendicular direction of said solid state image sensor, the captured area being an area on said original corresponding to said rectangular region of said solid state image sensor; and
a control section for scanning a two-dimensional image of said original by controlling at least said solid state image sensor and said moving section, wherein:
said control section includes a transfer control part for controlling said solid state image sensor to transfer the charge accumulated in each of the photosites in said rectangular region; and
said transfer control part simultaneously controls said transfer parts to simultaneously transfer said charge from each of said linear arrays of photosites.

3. The image scanner according to claim 2, wherein:
said control section includes a move control part for controlling said moving section to relatively move said captured area and said original by a fixed distance in said sub-scan direction after said illuminating section irradiates the illumination; and
said fixed distance is determined to be a length equivalent to a length of said captured area in said sub-scan direction.

4. The image scanner according to claim 2, wherein:
said control section includes a move control part for controlling said moving section to relatively move said captured area and said original by a fixed distance in said sub-scan direction after said illuminating section irradiates the illumination; and
said fixed distance is determined to be a length obtained by dividing the length of said captured area in said sub-scan direction by the number of said linear arrays of photosites.

5. The image scanner according to claim 2, wherein:
said control section includes a move control part for controlling said moving section to relatively move said captured area and said original by a fixed distance in said sub-scan direction after said illuminating section irradiates the illumination; and
said fixed distance is set to either of the length of said captured area in said sub-scan direction and a length obtained by dividing the length of said captured area in said sub-scan direction by the number of said linear arrays of photosites, according to a scan mode of the two-dimensional image of said original.

6. A image scanning program for scanning a two-dimensional image of an original by controlling at least a solid state image sensor and a moving section of an image scanner, the image scanner comprising:
an illuminating section for irradiating illumination to an original;
a solid state image sensor including; two or more linear arrays of photosites in which a plurality of photosites are closely and one-dimensionally arranged in one direction, the plurality of photosites being for accumulating charge in accordance with light from the illuminated original; and transfer parts provided for said two or more linear arrays of photosites respectively, for transferring, array by array, the charge accumulated in each of the photosites of said two or more linear arrays, in which said two or more linear arrays of photosites are closely arranged in a rectangular region in a direction perpendicular to said one direction, the rectangular region being long in said one direction; and
a moving section for relatively moving a captured area and said original in a sub-scan direction corresponding to said perpendicular direction of said solid state image sensor, the captured area being an area on said original corresponding to said rectangular region of said solid state image sensor, said image scanning program comprising the step of
controlling said solid state image sensor to transfer the charge accumulated in each of the photosites in said rectangular region, wherein
in the controlling step, said transfer parts are simultaneously controlled to transfer said charge from each of said linear arrays of photosites.

7. The image scanning program according to claim 6, further comprising the step of controlling said moving section to relatively move said captured area and said original by a fixed distance in said sub-scan direction after said illuminating section irradiates the illumination, wherein
in the moving controlling step, said captured area and said original are relatively moved so as to allow said fixed distance to be equivalent to the length of said captured area in said sub-scan direction.

8. The image scanning program according to claim 6, further comprising the step of a controlling said moving section to relatively move said captured area and said original by a fixed distance in said sub-scan direction after said illuminating section irradiates the illumination, wherein
in the moving controlling step, said captured area and said original are relatively moved so as to allow said fixed distance to be equivalent to a length obtained by dividing a length of said captured area in said sub-scan direction by the number of said linear arrays of photosites.

9. The image scanning program according to claim 6, further comprising the step of controlling said moving section to relatively move said captured area and said original by a fixed distance in said sub-scan direction after said illuminating section irradiates said illumination, wherein
in the moving controlling step, said fixed distance is set, according to a scan mode of the two-dimensional image of said original, to either of the length of said captured area in said sub-scan direction and a length obtained by dividing a length of said captured area in said sub-scan direction by the number of said linear arrays of photosites, thereby relatively moving said captured area and said original.
